(19) United States
(12) Patent Application Publication
(10) Pub. No.: US 2025/0312854 A1
(43) Pub. Date: Oct. 9, 2025

(54) MULTI-PHASE HEATING SYSTEMS FOR BIDISPERSED AND POLYDISPERSED PARTICLE APPLICATIONS

(71) Applicant: Oqab Dietrich Induction Inc., Kitchener (CA)

(72) Inventors: Haroon B. Oqab, Kitchener (CA); George B. Dietrich, Kitchener (CA); Ahmed Saieed, Kitchener (CA); Mustafa Mutiur Rahman, Kitchener (CA); Jean-Pierre Hickey, Kitchener (CA)

(21) Appl. No.: 18/881,629

(22) PCT Filed: Jul. 6, 2023
(86) PCT No.: PCT/CA2023/050915

§ 371 Date: Jan. 6, 2025

Related U.S. Application Data
(60) Provisional application No. 63/358,582, filed on Jul. 6, 2022.

(51) Int. Cl. B22F 12/13; B22F 12/53; B33Y 30/00

(52) U.S. Cl. CPC B22F 12/13; B22F 12/53; B33Y 30/00

(57) ABSTRACT

Provided are multi-phase heating systems for bidispersed and polydispersed particle applications. Provided is a multi-phase reactor comprising a reaction chamber for containing a catalyst wherein the catalyst reacts with a fluid material. A heating system arranged around the reaction chamber comprises a first heater for heating a core of the chamber and a second heater for heating a periphery of the chamber, where combined heating from the first and second heaters provide the reaction chamber at a temperature for clustering of the fluid material for reaction with the catalyst. Also provided is an additive manufacturing printer comprising a first heater for heating a core of the chamber and a second heater for heating a periphery of the chamber, wherein combined heating from the first and second heaters provide the chamber at a temperature for clustering of printable material for extrusion through a nozzle.

### TECHNICAL FIELD

The embodiments disclosed herein relate to dispersion and clustering of energetic particles, and, in particular to multi-phase heating systems for bidispersed and polydispersed particle applications.

### INTRODUCTION

Particle-laden flows arise in many geophysical phenomena, such as water droplets carried in clouds and dust particles in the air. They are also increasingly prevalent in many modern engineering applications, such as metallic dust flames (Blaise et al, Combust. Sci. Technolo. 1-14, 2020) and particle-laden solar receivers (Houf, W. & Greif, R. Chem. Eng. Commun. 51, 153-165, 1987). In these applications, the heat transfer between the solid and continuum phase (either gas or liquid) plays a defining role. Thus, efforts are directed at creating efficient interphase thermal transfer by promoting a homogeneous particle distribution within a turbulent flow.

Phenomenologically, the inhomogeneous particle distribution is predominantly the result of the centrifugal force from the vortices which expels the particles from high vorticity to high strain rate regions in a turbulent flow (Squires, K. D. & Eaton, J. K. Phys. Fluids A 3 (5), 1169-1178, 1991; Sundaram, S. & Collins, L. R. J. Fluid. Mech. 335, 75-109, 1997; Mclaughlin, J. Int. J. Multiph. Flow, 20, 211-232, 1994)—this phenomenon is known as preferential concentration. As turbulence is a multi-scale process, the vortical-based justification remains incomplete to explain clustering in high-Reynolds number flows. To extend this explanation, it has been argued that particles gather in regions of zero acceleration (Coleman, S. & Vassilicos, J., Phys. Fluids 21 (11), 113301, 2009; Goto, S. & Vassilicos, J. Phys., Rev. Lett. 100 (5), 054503, 2008) which are located in the convergence zones between two or more coherent vortical structures in the flow (Squires, K. D. & Eaton, supra). Chen, L. et al. (J. Fluid Mech. 553, 143-154, 2006), studied this phenomenon numerically and stated that the inertial particles tend to avoid the streamline curvatures of the flow field and gather at the points of zero-acceleration and advect with them. As the fluid acceleration is null at these points, there is no net force acting on the particles to change their position when the particles are moving at the local fluid velocity. On the other hand, another explanation of particle clustering was contributed by Chun, J. et al. (J. Fluids Mech. 536, 219-251, 2005), where clustering at scales smaller than Kolmogorov length scales occurs due to the fluid-particle relative drift velocity which brings them close to each other. Hence, although there are many proposed mechanisms that explain particles clustering, including for compressible flows (Haugen, N. E. L., et al., J. Fluid Mech. 934, 2022), there is a general consensus on the importance of particle clustering in turbulent flows.

Preferential concentration creates zones of high-particle concentration and, by extension, zones of low-particle concentration. When the particles are heated, for example through radiation (Beyrau, et al., Proc. Combust. Inst. 34 (2), 2065-2072, 2013) or induction (Mouallem, J. & Hickey, J. P., Int. J. Multipl. Flow, 132, 103414, 2020), the heat is readily transferred to the continuum phase in the immediate vicinity of the particles, whereas the gas farther away experiences a delay in the heat transfer (Apperson, S. et al., Appl. Phys. Lett. 91 (24), 243109, 2007). These two zones of high and low particle concentration are separated by a region of significant temperature (or any other scalar field) gradient known as a front (Bec, J. et al., Phys. Rev. Lett. 112 (23), 234503, 2014; Carbone, M. et al., J. Fluid Mech. 881, 679-721, 2019). Thus, particles clustering results in irregular heating, regions of unequal temperature distribution and consequently uneven expansion of the gas. It was reported that preferential concentration can hinder the particle-to-gas heat transfer by up to 25% (Pouransari, H. & Mani, A., J. Solar Energy Eng. 139 (2), 2017). Hence, understanding the formation of these clusters and their impact on the interphase heat transfer is crucial for the state-of-the-art particle-laden flow applications with heat transfer.

The primary variables governing the particle dispersion are particle size, weight as well as the turbulence characteristics (defined mainly by the integral, Taylor and Kolmogorov scales) (Sumbekova, S. et al., Phys. Rev. Fluids 2 (2), 024302, 2017). These parameters directly influence the particle Stokes number (St), which is considered to be the fundamental quantity regulating the particle distribution in a continuum phase (Zhou, Y. et al. J. Fluid Mech. 433, 77-104, 2001; Vie, A. et al. J. Multiph. Flow, 79, 144-158, 2016). The Stokes number is a measure of the particle inertia as it relates the particle characteristic timescale (τₚ) with an appropriate turbulent timescale (t). Mathematically, it is expressed as (Crowe, C. et al. Particul. Sci. Technol. 3 (3-4), 149-158, 1985):

$$St = \frac{{τ}_{p}}{τ} \qquad ( 1 )$$

where, τₚ is the time required for the particle to adjust to the changes in the flow field; a particle with small τₚ rapidly adapts to changes in the flow. The mathematical definition of τₚ is (Stokes, G. et al. On the Effect of the Internal Friction of Fluids on the Motion of Pendulums. Pitt Press Cambridge, 1851):

$${τ}_{p} = \frac{{ρ}_{p} {d}_{p}^{2}}{18 {ρ}_{f} {v}_{f}} \qquad ( 2 )$$

where ρ_{p/f}, dₚ and v_{f} are the particle/fluid density, particle diameter and fluid kinematic viscosity, respectively.

The turbulent timescale, τ, can be defined based on a relevant characteristic timescale of the turbulence such as Kolmogorov (τ_{η}) or integral (τ_{ι}) timescales. There exists a general agreement that the preferential concentration is maximum at intermediate Stokes number, for St based on Kolmogorov scale this corresponds to unity (St_{η}≈1) (Bragg, A. D. et al. Phys. Rev. E 92 (2), 023029, 2015). Particles with St_{η}<<1 closely espouse the flow streamlines, whereas St_{η}>1 possess substantially higher inertia which cause them to follow their own trajectory with a reduced influence of the small scale turbulence (Zaichik, L. I. & Alipchenkov, V. M. Phys. Fluids 19 (11), 113308, 2007; Bec, J. et al Phys. Rev. Lett. 98 (8), 084502, 2007). However, it is also observed that clustering occurs at all Stokes numbers. In the literature, this is explained with two different St_{η} based regimes. For particles with St_{η} less than unity, the primary reason for clustering is the centrifugal force as explained earlier (Squires & Eaton, supra). Whereas, for particles with St_{η}≥1, the centrifugal force may not be the dominant cause of clustering. In this case, clustering is ascribed to a time based non-local mechanism, where particles cluster due to the memory effect of them interacting with the turbulent flow field along their path history (Bragg, A. D. & Collins, L. R. New J. Phys. 16 (5), 055013, 2014).

Determining the propensity of particles to cluster is more complex than simply looking at the Stokes number. As seen in the above discussion, τ_{η} is commonly used for defining particle distribution and St, since clustering is primarily governed at the dissipation scale (Bec, J. et al., 2007, supra; Baker, L. et al. J. Fluid Mech. 833, 364-398, 2017). Yet, the choice of appropriate timescale is more nuanced as the particle response to turbulence depends on the particle size (Eaton, J. K. & Fessler, J. Int. J. Multiph. Flow. 20, 169-209, 1994). This is particularly important in polydispersed flows which contain a range of particle sizes. Additional complexities arises when the particles are externally heated. As can be observed from equation (2), the particle relaxation time can change as the local fluid viscosity and density—both a function of temperature—about the heated particles vary with time and space. Therefore, the change in the particle timescale is a function of the state of the fluid: in gas, the viscosity increases with temperature, whereas it decreases in liquid. In both phases, the fluid density (generally) decreases with the increase in temperature, although the magnitude of the change is much greater in gas, assuming the liquid does not undergo a phase change. These critical factors govern the value of the St and, concomitantly, impact the distribution of the particles.

In addition to the temporal change of the particle timescale, the turbulence characteristics are modified in a temporally evolving flow. In this regard, the Kolmogorov (τ_{η}) and integral (τ_{ι}) timescales are given as:

$${τ}_{η} = {( \frac{v}{ε} )}^{\frac{1}{2}} \qquad ( 3 )$$

$${τ}_{l} = \frac{{( T K E )}^{\frac{3}{2}}}{ε {u}_{r m s}} \qquad ( 4 )$$

In these equations, TKE is the turbulent kinetic energy and ε is the dissipation rate of TKE. Thus, as turbulence decays, τ_{η} starts to increase as ε decreases. Whereas, TKE, ε and uᵣₘₛ simultaneously drop in such a way that τ_{ι} depicts an overall decreasing trend as per equation (4). Similarly, in accordance with equation (1), as the turbulence decays, Stₙ decreases, while the integral scale based Stokes number (Stₗ) increases. This contradicting response of large and small timescales towards decaying turbulence can play a significant role in the distribution of particles that are of different sizes. This is especially critical if the particles are heated as it also varies the local density and viscosity. This is critical in practical applications where a range of particle sizes exist (Sahu, S. et al., J. Fluid Mech. 794, 267-309, 2016), which correspond to a variety of St at any given instance (Saw, E.-W. et al., New J. Phys. 14 (10), 105030, 2012). Therefore, ensuring the uniform distribution of polydispersed particles is a remarkably convoluted task.

Although most of the previous literature is focused on the numerical (Hardalupas, Y. et al., Proc. R. Soc. Lond. Ser. A Math. Phys. Eng. Sci. 428 (1874), 129-155, 1990; Wang, L.-P. & Maxey, M. R. J. Fluid Mech. 256, 27-68, 1993; Bec, J., J. Fluid Mech. 528, 255-277, 2005) and experimental (Lian, H., Droplet Preferential Concentration in Homogeneous and Isotropic Turbulence, Imperial College London, 2014; Monchaux, R. et al., Phys. Fluids 22 (10), 103304, 2010) understanding of monodispersed particle-laden flows, a number of studies have also been conducted on the behavior of poly-dispersed cases. Saw et al., 2012, supra, compared the clustering characteristic of a polydispersed and monodispersed flow. By using direct numerical simulation (DNS), they modeled polydispersed flow comprising of 250 discrete St_{η} between 0.01 and 1.2, and revealed that different species of particles gather in different locations in the flow. Zhou et al., supra, also reported a similar observation in bidispersed flows. Therefore, a better overall particle distribution is obtained in polydispersed particles. Likewise, Ayala et al. (New J. Phys. 10 (7), 075015, 2008) studied polydispersed flows and reinforced this observation by reporting that particles of different sizes respond to different scales of turbulence. Additionally, the enhancement in particle distribution in bidispersed flows was also attributed to the difference in acceleration of the two particles sizes (high particle-particle relative velocity), which results in superior diffusion (Dhariwal, R. & Bragg, A. D. J. Fluid Mech. 839, 594-620, 2018). Saw et al. (Phys. Rev. Lett. 100 (21), 214501, 2008) studied the clustering and coalescence of droplets in a range of Stₙ. Considering that clustering is most pronounced at the dissipation scale, they used the Kolmogorov scale to characterize the particle distribution. It was observed that in polydispersed flows at Stₙ<<1, the particle clustering is enhanced with the increase in St_{η} similar to monodispersed flows (Chun et al., supra). Pan et al. (Astrophys. J. 740 (1), 6, 2011) further added that for large particles with Stₙ>1, the clustering intensity dwindles with the increase in Stₙ. The turning point between these two trends is Stₙ≈1, where maximum preferential concentration occurs (Letournel, R. et al., Reproducing segregation and particle dynamics in Large Eddy Simulation of particle-laden flows. In: International Conference on Liquid Atomization and Spray Systems (ICLASS), Vol. 1, 1, 2021).

The dispersion characteristics of heated polydispersed particles have not gained much attention, as most of the research on heated particle-laden flows has focused on monodispersed particles (Pouransari, H. & Mani, A., Phys. Rev. Fluids 3 (7), 074304, 2018; Esmaily-Moghadam, M. & Mani, A. Phys. Rev. Fluids 1 (8), 084202, 2016). In this regard, a pioneering study was reported by Rahmani et al. (Int. J. Multiph. Flow. 104, 42-59, 2018) in which they compared the distribution of radiatively heated mono- and polydispersed Nickel particles in a turbulent channel flow. At low Stₙ, they did not notice any significant difference in the distribution of mono- and polydispersed particles. However, at intermediate and reasonably high St_{η} ranging from 0.08 to 0.85 and 0.21 to 2.31, polydispersed particles showed substantially better particle distribution than their monodispersed counterparts. In addition, polydispersed particles resulted in a more uniform temperature of the gaseous phase. They also explained this even particle and temperature distribution by the difference in centrifugal force acting on the inertial particles of dissimilar sizes, which causes them to gather in distinct regions around the same vortex. Thus, this size-wise clustering of polydispersed particle flow results in a better homogeneity in the aggregate.

Based on the discussion above, a fundamental scientific question that deserves closer scrutiny is the effect of fluid viscosity on the grouping of heated particles as it has not been studied so far. The importance of temperature-dependent gas viscosity on the particle distribution was noted by Mouallem and Hickey, 2020. By inductively heating particles with different heating response times in gas, they observed, unsurprisingly, an increased TKE decay rate. However, the influence of the viscosity on clustering was not the main focus of their study. Hence, it is possible that preferential concentration is affected by the temperature-dependent viscosity, since the fluid timescales directly govern the evolution of Stₗ and Stₙ in decaying turbulence. If this is true, then the existing knowledge of heated particle distribution might not be directly applicable to clustering sensitive applications.

Considering the discussion above, there is a need to gain an understanding of the distribution of heated bidispersed particles with a liquid- and gas-like temperature-dependent viscosity in decaying isotropic turbulence for development of bidispersed and polydispsersed energetic particles and heated multiphase systems for various applications.

### SUMMARY

The effect of temperature-dependent viscosity on the preferential concentration of bidispersed, externally-heated solid particles in decaying isotropic turbulence via direct numerical simulations (DNS) is described. More specifically, we investigated the role of liquid- and gas-like viscosity-which respectively decrease and increase with temperature-on the preferential concentration of small and large particles due to turbulence. The bidispersed particles enhance the overall distribution compared to monodispersed flows as the voids created by the particles of one size are occupied by the other particles.

Particle clusters emerge irrespective of the Stokes number although the clustering characteristics differ based on the functional form of the temperature-dependent viscosity. When particles are externally heated in a variable viscosity flow, the Kolmogorov-based Stokes number, Stₙ, is not sufficient to predict preferential concentration. Increased clustering is observed, especially for small-sized particles, as the fluid is heated and turbulence decays. This increased clustering is explained through a viscous capturing mechanism in which the initial clustering, prior to the onset of heating, is responsible for the creation of local hot-spots in the flow as the particles are heated. In a gas, these higher temperature regions have higher viscosity which cause other particles to be captured due to the increased drag. The increased drag of the gas results in a lower fluid-particle drift velocity as compared to the liquid, despite the significantly lower turbulent kinetic energy of the flow. The relative distribution of the particles as a function of vorticity and strain rate magnitude reveals a bimodal distribution in which a higher proportion of the particles aggregate in mid- and high-strain/vorticity regions as the turbulence decays.

According to an embodiment, there is a multi-phase reactor comprising a reaction chamber for containing a catalyst wherein the catalyst reacts with a fluid material and a heating system arranged around the reaction chamber. The heating system comprises a first heater for heating a core of the reaction chamber; and a second heater for heating a periphery of the reaction chamber, where combined heating from the first heater and the second heater provide the reaction chamber at a temperature for clustering of the fluid material for reaction with the catalyst.

The fluid material may be a slurry, a liquid, a gas, or a combination thereof. The catalyst may comprises a porous scaffold through which the fluid material can flow and functionalized catalyst beads embedded in the porous scaffold. The catalyst beads may be a metal or a metal oxide. The catalyst may comprise a wash coat catalyst.

The first heater is preferably an induction heater wrapping around the reaction chamber. The second heater is one of a microwave heater, a heating element and a laser.

According to an embodiment, there is an additive manufacturing printer comprising a platform for receiving a printable material thereon, a liquifier chamber, wherein the printable material is heated to an extrudable state within the chamber, a nozzle in fluidic connection with the chamber for extruding the printable material onto the platform and a heating system around the chamber, for heating reaction chamber and the printable material therein. The printer may include a mixing chamber for mixing the printable material with a carrier fluid.

The heating system comprises a first heater for heating a core of the chamber and a second heater for heating a periphery of the chamber, wherein combined heating from the first heater and the second heater provide the chamber at a temperature for clustering of the printable material for extrusion through the nozzle. According to some embodiments, the heating system includes a third heater for heating the nozzle to a temperature for optimal clustering of the printable material as it is extruded through the nozzle. According to some embodiments, the heating system includes a fourth heater for heating the platform to a temperature for optimal clustering of the printable material after extrusion from the nozzle.

According to an embodiment there is a mobile additive manufacturing system comprising an aerial craft and an additive manufacturing printer mounted to the aerial craft.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a plot comparing the evolution of the particle and fluid temperatures normalized with temperature, in base case 1;

FIGS. 2A-2B are plots showing evolution of normalized Integral (ti) and Kolmogorov (τ_{η}) timescales, respectively, in base case 1;

FIG. 3 is a plot of variation in normalized TKE with respect to the flow time, in base case 1;

FIGS. 4A-4B are plots showing evolution of Stokes number for large particles (St_{l,large}) and small particles (St_{η,small}), respectively, with time, in base cases 1-3;

FIGS. 5A-5B are radial distribution function (RDF) curves showing clustering of small and large particles, respectively, at t=1, in base cases 1-3;

FIGS. 5C-5D are radial distribution function (RDF) curves showing clustering of small and large particles, respectively, at half TKE, in base cases 1-3;

FIGS. 5E-5F are radial distribution function (RDF) curves showing clustering of small and large particles, respectively, at t=10, in base cases 1-3;

FIGS. 6A-6F are radial distribution function (RDF) curves showing clustering of small and large particles in base case 2, at even timesteps under different conditions;

FIG. 7 is a diagram of the effect of heating on discrete particle drag force in a gas;

FIG. 8 is probability distribution function (PDF) curves of fluid-particle drift velocity normalized with Kolmogorov velocity in heated gas and liquid at even timesteps;

FIG. 9 is a plot of peak values of the PDF curves in FIG. 8;

FIG. 10 is temperature contour plots of gas with particle distribution at different timesteps, in base cases 1-3;

FIG. 11 is temperature contour plots of liquid with particle distribution at different timesteps, in base cases 1-3;

FIGS. 12A-12B are plots showing distribution of the gas and liquid particles, respectively, as a function of strain rate at t=1, in base cases 1-3;

FIGS. 12C-12D are plots showing distribution of the gas and liquid particles, respectively, as a function of strain rate at half TKE, in base cases 1-3;

FIGS. 12E-12F are plots showing distribution of the gas and liquid particles, respectively, as a function of strain rate at t=10, in base cases 1-3;

FIGS. 13A-13B are plots showing distribution of the gas and liquid particles, respectively, as a function of vorticity at t=1, in base cases 1-3;

FIGS. 13C-13D are plots showing distribution of the gas and liquid particles, respectively, as a function of vorticity at half TKE, in base cases 1-3;

FIGS. 13E-13F are plots showing distribution of the gas and liquid particles, respectively, as a function of vorticity at t=10, in base cases 1-3;

FIG. 14 is plots of the difference between the number of small and large particles in different strain rate regions;

FIG. 15 is plots of the difference between the number of small and large particles in different vorticity regions;

FIGS. 16A-16C are diagrams of 3D distribution of particles and vortices for small particles, large particles and small and large particles, respectively;

FIGS. 17A-17B are mean energy spectra with 384³ and 512³ mesh resolution at t=0 and t=6, respectively;

FIG. 18 is a diagram of a multi-source multi-phase reactor, according to an embodiment;

FIGS. 19A-19B are diagrams of multi-phase reactors, according to several embodiments;

FIGS. 20-21 are diagrams of catalyst bed structures, according to several embodiments;

FIG. 22 is a diagram of a hybrid molten salt reaction, according to an embodiment;

FIG. 23 is a diagram of a multi-phase thermal battery system, according to an embodiment;

FIG. 24 is a diagram of a multi-phase heating system for additive manufacturing, according to an embodiment;

FIGS. 25A-25B are diagrams of high and low pressure cold spraying systems, respectively, according to several embodiments;

FIG. 26 is a diagram of a mobile printing system, according to an embodiment; and

FIG. 27 is a diagram of a multi-phase heating system with a multi-source energy system, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

### Methodology

In this study, DNS were carried out using a highly parallel finite difference, open-source code, namely the Pencil-Code (Brandenburg, A. et al., The pencil code, a modular MPI code for partial differential equations and particles: multipurpose and multiuser-maintained, arXiv preprint 2009.08231, 2020). This code was extended to include temperature-dependent viscosity—following a power-law—of a representative liquid- and gas-like phase. Three cases, with different bidispersed particle sizes, are simulated with liquid- and gas-like temperature-dependent viscosity; comparative constant viscosity simulations are also investigated. The fluid and particles were respectively modeled using Eulerian and Lagrangian point particle tracking schemes. A tri-linear interpolation of the continuum phase was used to advance the particle position. For the fluid-particle momentum integration, a collision-less, one-way coupling scheme was employed in order to isolate the effect of temperature-dependent fluid viscosity on particle dispersion. A similar approach was adopted by Carbone et al., supra, for investigating the interaction of fluid-particle temperature fields. On the other hand, for the energy equation, a two-way coupling was selected. The solution of the continuum phase relied on a high-order finite difference method for spatial derivatives and a third-order Runge-Kutta scheme for the time marching.

Particle-laden decaying homogeneous isotropic turbulence (HIT) was simulated in a cubic box of characteristic length 2π using 384³ grid cells, and periodic boundary conditions were imposed in all three spatial directions. A total of 500,000 spherical particles, of two different sizes, were randomly dispersed in the domain. To investigate various effects of particle St, three initializing simulations with different bidispersed particle sizes were first simulated, without heating, and with a solenoidal forcing term in order to sustain the HIT (Brandenburg, A., et al. Astrophys. J. 550 (2), 824, 2001) prior to the turbulence decay. These initializing simulations will be referred to as “base cases” below. The initializing simulations were run for about 4-5 eddy turnover times, which allowed for the stabilization of the turbulence characteristics such as the root-mean-square velocity (uᵣₘₛ).

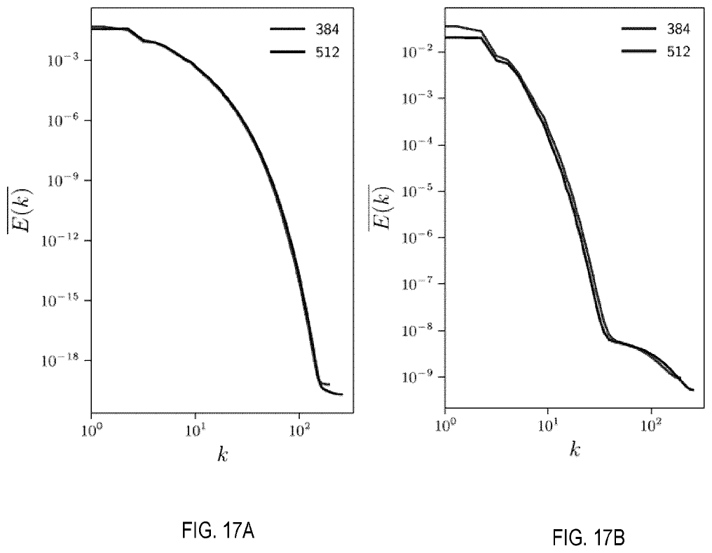

To ensure that the present model is independent of the selected mesh, we carried out a mesh independence study in which 384³ base case 2 and Gas 2 were reran with 512³ grid resolution. FIG. 17 exhibits the comparison of the mean energy spectrum (E(k)) observed after the statistical steady state was achieved in base case 2 and at t=6 in the Gas 2 simulation. Here, it can be witnessed that the E(k) curves of the test cases are practically identical and perfectly depict the entire energy spectrum. Based on this, it can be stated that the prepared model is independent of the chosen grid resolution.

It should be noted that all simulation parameters are presented in consistent but arbitrary units. Although the variable density Navier-Stokes equations were solved, both gas- and liquid-like cases were run at a nearly incompressible limit. The Mach number of the simulations at the start of the turbulent decay was 0.086 based on the maximum local velocity. For the flow field initialization (prior to the particle heating and turbulence decay), the particle temperature was stabilized to 300; thus, for the initialization we assume a constant viscosity. To sustain the turbulence, a forcing was applied at a low wavenumber to provide energy to the larger eddies; the forcing wavenumber was 1.5 which is almost equal to the minimum wavenumber of the simulation (k=1.29). The Taylor-based Reynolds number (Re_{λ}=uᵣₘₛλ/v_{f}, where λ is the Taylor length scale) of 98 is achieved once the flow is fully developed. Similarly, Kₘₐₓη≈10 was obtained in the present study, which ensures the complete resolution of the small scales (Pope, S. B., Turbulent Flows, Cambridge University Press, 2000). The turbulence characteristics, at the end of the initialization, are listed in Table 1. These parameters are identical in the three base cases due to one-way coupling in the momentum equation, as the only difference between the base cases is the particle size. As seen in Table 1, two slightly different time instances were selected as initial conditions for the gas- and liquid-like simulations. Since the decaying viscosity of the liquid imposed a more stringent resolution requirement, a time instant with a slightly lower turbulence intensity was selected. The gas simulations were initialized at a later time instant which had a higher instantaneous turbulent kinetic energy. Despite the instantaneous difference in the turbulent kinetic energy between the gas and liquid cases, the overall turbulence statistics remain similar.

TABLE 1
Characteristics of the fully developed HIT.

| Variable | Symbol | Liquid Cases | Gas Cases |
|---|---|---|---|
| Taylor Reynolds number | Re_{λ} | 94 | 98 |
| Turbulent Reynolds number | Re_{T} | 489 | 510 |
| Average root-mean-square velocity | uᵣₘₛ | 0.40 | 0.52 |
| Turbulent kinetic energy | TKE | 0.10 | 0.13 |
| Rate of dissipation | ε | 0.0048 | 0.0050 |
| Turbulence forcing length scale | L_{force} | 4.19 | 4.19 |
| Kolmogorov timescale | τ_{η} | 0.84 | 0.84 |
| Kolmogorov length scale | η | 0.053 | 0.053 |
| Integral timescale | τ_{ι} | 14.58 | 19.59 |
| Integral length scale | / | 6.59 | 9.37 |

After initialization- and once the statistically-steady state was achieved—the forcing was turned off and particle heating was initiated. For each of the three statistically-steady base cases, two different temperature-dependent viscosity models were used to account for the viscous effects during the turbulence decay: (1) an increasing viscosity with increasing temperature model, which corresponds to the typical viscosity behaviour of a gas, and (2) a decreasing viscosity with increasing temperature model, which corresponds to a liquid. The functional form of these viscosity models is presented below. For simplicity, the phase change that could arise in the liquid-like case was neglected.

The particle radii along with corresponding integral-scale Stokes number St_{l,large} (large particle) and Kolmogorov Stokes number St_{η, small} (small particle) values at t=0 of the three gas and liquid simulations are listed in Table 2. As shown in this table, the small particles is referred to only by St_{η,small} and the large particles by St_{l,large}, recognizing that these Stokes number definitions can be used to define both particle sizes. We selected this notation to simplify the discussion as we know that the motion of small and large particles are primarily governed by Kolmogorov and integral timescales, respectively. Considering Table 2, from here onward each of the six simulations (three base cases each with gas and liquid) will be referred by the phase of the carrier fluid (either liquid or gas) and its corresponding base case number (either 1, 2 or 3 with differing particle sizes). For instance, Gas 1 stands for gas phase and base case number 1, while Liquid 1 represents liquid carrier phase and base case 1 of small and large particle radii. The particle heating, as discussed later, is the same among all cases.

TABLE 2
Combinations of small and large particle radii and Stokes number
at t = 0 of the gas and liquid simulations with heating.

| | Base Case | | | | | |
|---|---|---|---|---|---|---|
| | 1 | | 2 | | 3 | |
| | Particle species | | | | | |
| | large | small | large | small | large | small |
| Particle radius | 0.0047 | 0.0012 | 0.0106 | 0.0028 | 0.0183 | 0.0028 |
| Stokes Number | St_{l, large} | St_{η, small} | St_{l, large} | St_{η, small} | St_{l, large} | St_{η, small} |
| Gas | 0.10 | 0.19 | 0.46 | 0.94 | 1.40 | 0.95 |
| Liquid | 0.21 | 0.22 | 1.10 | 1.11 | 3.30 | 1.11 |

### Carrier Phase

The governing equations of the fluid mass, momentum and energy conservation are as follows (The Pencil Code, 2022, NORDITA <pencil-code.nordita.org>):

$$\frac{\partial ρ}{\partial t} + \frac{\partial ρ {u}_{i}}{\partial {x}_{i}} = 0 \qquad ( 5 )$$

$$\frac{\partial {pu}_{i}}{\partial t} + \frac{\partial {pu}_{i} {u}_{i}}{\partial {x}_{j}} = \frac{\partial p}{\partial {x}_{i}} + \frac{\partial {u}_{f}}{\partial {x}_{j}} ( \frac{\partial {u}_{i}}{\partial {x}_{j}} + \frac{\partial {u}_{j}}{\partial {x}_{i}} - \frac{2}{3} \frac{\partial {u}_{k}}{\partial {x}_{k}} {δ}_{ij} ) + {F}_{i} \qquad ( 6 )$$

$$\frac{\partial ( ρ {C}_{v , f} {T}_{f} )}{\partial t} + \frac{\partial ( ρ {C}_{p , f} {T}_{f} {u}_{j} )}{\partial {x}_{j}} = \frac{\partial }{\partial {x}_{j}} ( {k}_{f} \frac{\partial {T}_{f}}{\partial {x}_{j}} ) + {Q}_{pf} \qquad ( 7 )$$

where p and T are the thermodynamic pressure and temperature, while uᵢ the fluid velocity in i^{th} direction. Similarly, k_{f}, C_{p,f} and C_{v,f} are the fluid thermal conductivity, specific heat at constant pressure and volume, respectively. We note that the thermal conductivity is computed based on a constant Prandtl number assumption, whereas the viscosity was computed using a power-law, as described below. Fᵢ is the forcing term, which was prescribed to develop HIT during the initialization; this term is Fᵢ=0 once the particles are heated and the turbulence decays. Given the low Mach number, the conservation of energy only accounts for the internal energy, which is a function of temperature. Note that the gravitational force was neglected.

As per the above stated objectives, two temperature-dependent viscosity models were implemented. The other thermophysical properties of the fluid, such as specific heat, were not modified. This is obviously a simplification as the viscosity can be defined from a molecular dynamic perspective and it is dependent on the thermodynamic properties of the fluid. Also, from a molecular dynamics perspective, it is expected that changes in the viscosity will be mirrored by changes in thermal conductivity, which are also not modified between the gas- and liquid-like simulations. Finally, the models do not account for phase change in the liquid-like simulation. These simplifications, albeit slightly reductive of the actual physics, were consciously made to clearly isolate the temperature-dependent viscous effects from the other thermophysical aspects of the flow. Based on this, the power-law form of the gas viscosity is:

$${μ}_{f} = {v}_{f , 0} {{ρ}_{f} ( T / {T}_{0} )}^{\frac{2}{3}} \qquad ( 8 )$$

where u_{f} is the dynamic viscosity, while subscript 0 represent a reference value. To model the liquid-like viscosity, the mathematical expression is:

$${μ}_{f} = {v}_{f , 0} {{ρ}_{f} ( {T}_{0} / T )}^{\frac{2}{3}} \qquad ( 9 )$$

Comparing equations (8) and (9), it is clear that the gas and liquid viscosity are identical except for the inverted temperature ratio. The initial kinematic viscosity in the base simulations was 0.0034. For brevity, we will denote the simulations as a gas when equation (8) is used, and as a liquid when the viscosity is defined with equation (9). As we are using the ideal gas law to relate the thermodynamics in both cases (albeit at very low Mach number), we are formally not simulating a true liquid but, instead, isolating the effects of change in fluid viscosity with temperature on particle distribution, as discussed above. It should be noted that T in these expressions is 273 which was taken as the initial temperature of the base simulations. Therefore, once the heated simulations of the gas and liquid carrier phases were started, their corresponding viscosity underwent a slight readjustment, which was small enough that it did not affect the consistency of the results. Also note that below, the normalized dynamic viscosity (μ*=μ_{f}/μ_{f,0}, where μ_{f,0} is the reference dynamic viscosity just before heating) will be employed for analysis.

### Particulate Phase

The Lagrangian equations of motion for the particles are:

$$\frac{{dx}_{p , i}}{dt} = {u}_{p , i} \qquad ( 10 )$$

$$\frac{{du}_{p , i}}{dt} = \frac{{C}_{D}}{{τ}_{p}} ( {u}_{f , i} ( {x}_{p , i} ) - {u}_{p , i} ) \qquad ( 11 )$$

where u_{p,i} and u_{f,i}(x_{p,i}) are the particle velocity at i^{th} position and undisturbed fluid velocity at position x_{p,i}, C_{D} is the drag coefficient experienced by each particle dispersed in the carrier phase. It is a function of the local flow Reynolds number (Re) and is defined based on the Schiller-Naumann correlation (Schiller, N., VDI Zeitung 77, 318-320, 1935):

$${C}_{D} = 1 + 0 \text{.15} {Re}_{p}^{0.687} \qquad ( 12 )$$

where Reₚ is the particle Reynolds number:

$${Re}_{p} = \frac{{d}_{p} \vert {u}_{i} - {u}_{p , i} \vert}{{v}_{f}} \qquad ( 13 )$$

where |uᵢ−u_{p,i}| represents the local velocity difference between the fluid and particle.

### Heating Module

Particles were externally heated using the model proposed by Mouallem and Hickey, 2020. The particle heating term Q is mathematically given as:

$$Q = {m}_{p} {C}_{p , p} \frac{( {T}_{m ax} - {T}_{p} )}{{τ}_{heat}} \qquad ( 14 )$$

where Tₘₐₓ represents the maximum temperature the particles can reach from the external heat source, and τₕₑₐₜ is the timescale of the particle heating which was unity in our simulations (Mouallem & Hickey, 2020). Additionally, particle-fluid heat transfer Q_{p,f} can be defined as:

$${Q}_{p , f} = \frac{{m}_{p} {C}_{p , p} {Nu}_{p}}{2 {τ}_{th}} ( {T}_{p} - {\tilde{T}}_{p} ) \qquad ( 15 )$$

In this case, mₚ, Nuₚ, Tₚ, C_{p,p} and \tilde{T}ₚ are the mass, Nusselt number, temperature, heat capacity of the particles and temperature of the undisturbed fluid at the location of the particle, respectively. Similarly, τₜₕ is the thermal relaxation time which is prescribed as 10. Based on this, the thermal Stokes number Stₜₕ=τₜₕ/τ_{η}) of the particle heating is 11.9. Note that a smaller value of τₜₕ correlates to a faster transfer of heat from the particles to the carrier fluid. While, Nuₚ was computed using Ranz-Marshall equation (Marshall, W. & Ranz, W., Chem. Eng. Prog. 48 (3), 141-146, 1952):

$${Nu}_{p} = \frac{{h}_{p} {d}_{p}}{{k}_{f}} = 2 + 0.6 {Re}_{p}^{0.5} {Pr}^{0.3} \qquad ( 16 )$$

where, Pr is the Prandtl number (Pr=μ_{f}C_{p,p}/K_{f}).

### Radial Distribution Function

Since the primary focus of this study is to analyze clustering in bidispersed flows, the distribution of the particles was studied by evaluating the radial distribution function (RDF). It is a statistical method, which computes the probability of finding particles at a certain distance from a reference particle. The RDF is mathematically defined as:

$$R D F = \frac{{dN}_{p} ( r )}{4 π {r}^{2} {n}_{0} dr} \qquad ( 17 )$$

As per the above equation, the RDF of unity represents uniform distribution, while higher values indicate clustering (Sahu, S. et al. J. Fluid Mech. 846, 37-81, 2018). In equation (17), dNₚ(r) is the number of particles that lie within the distance r and r+dr from the reference particle and no stands for the particle concentration per volume. For this analysis, separate RDF curves were evaluated for large and small particles for a better understanding of their agglomeration behavior. There are other methods of determining particle clustering such as Voronoi analysis (Momenifar, M. & Bragg, A. D., Phys. Rev. Fluids 5 (3), 034306, 2020) and box counting (Fessler, J. R., et al., Phys. Fluids 6 (11), 3742-3749, 1994), yet for this study RDF was preferred as it is the most widely accepted method for characterizing preferential concentration (Monchaux, R. et al., Int. J. Multiph. Flow. 40, 1-18, 2012).

### Results

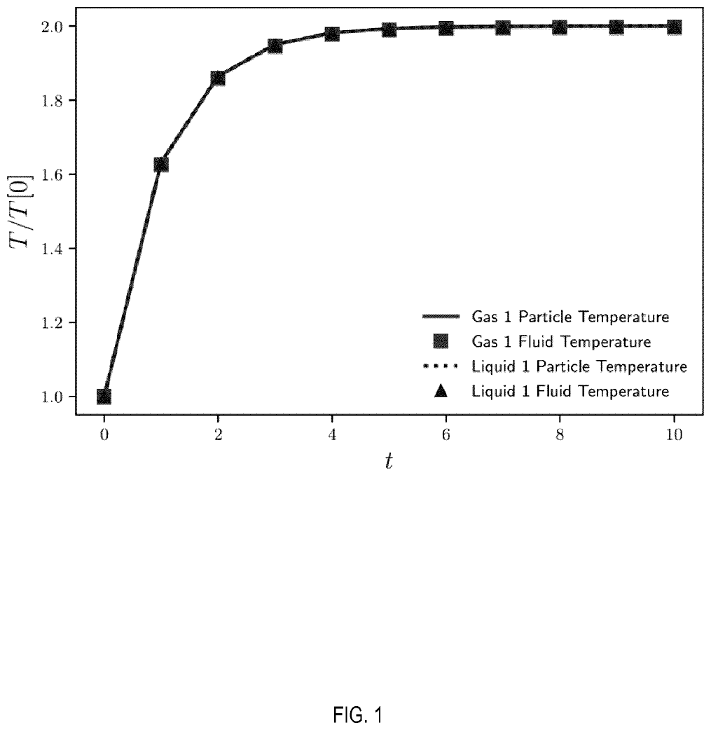

To assess the heat transfer characteristic between the dispersed and continuum phases, the evolution of the particle and fluid temperatures in the decaying HIT for Gas 1 and Liquid 1 are analyzed. Here, the average particle and fluid temperatures normalized with the initial temperature at t=0 was computed during the turbulence decay, as shown in FIG. 1. As expected, the particle and fluid temperature curves for both test cases perfectly overlap. This is due to the fast thermal timescale of the heat transfer (τₜₕ=10), which depicts a rapid adaptation of the fluid temperature to the temperature of the particles. The obtained curves can be divided into two heating regimes following the study by Pouransari and Mani, 2017, supra. Here, the initial rapidly rising temperature, until about t=4, is called the fast initial particle heating, while the flat section of the curve is called slow mixture heating. Similar particle heating plots were reported by Bae, D. et al. J. Ind. Eng. Chem. 30, 92-97, 2015; Mouallem and Hickey, 2020, supra; Rahmani et al., supra; Dai, Q. et al. Phys. Fluids 33 (9), 093312, 2021. Hence, a good particle-fluid coupling is obtained for both liquid and gas simulations.

### Evolution of Timescales

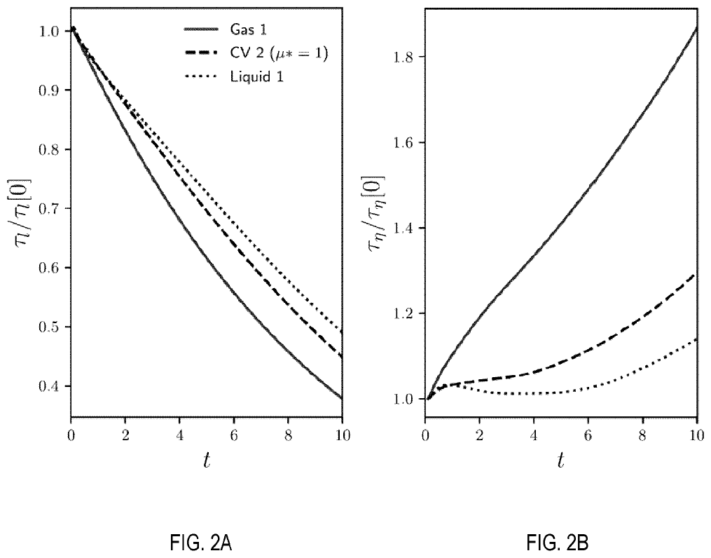

As stated earlier, in decaying HIT the evolution of St_{l,large} (the larger of the bidispersed particles) and St_{η,small} (the smaller of the bidispersed particles) is primarily governed by the characteristic timescales of the turbulence. In this regard, FIGS. 2A-2B show the evolution of the turbulence timescales, namely τₗ (integral) and τ_{η} (Kolmogorov), normalized with their respective values at t=0—at the start of the turbulence decay. Since all the base cases of gas and liquid perfectly overlapped due to one-way momentum coupling, only Gas 1 and Liquid 1 are shown in FIG. 2A. Note that upon heating the gas and liquid viscosity varied from 1.0 to 1.7 and 1.0 to 0.6, respectively. A heated, constant viscosity (CV 2) case was also simulated—with a bidispersed particle size identical to Gas 2 and fixed viscosity (μ*), the value of which is shown in the brackets. This comparative case is plotted as a reference. Gas 2 is selected as a reference case for this and the following plots as it showed maximum clustering among all the cases considered.

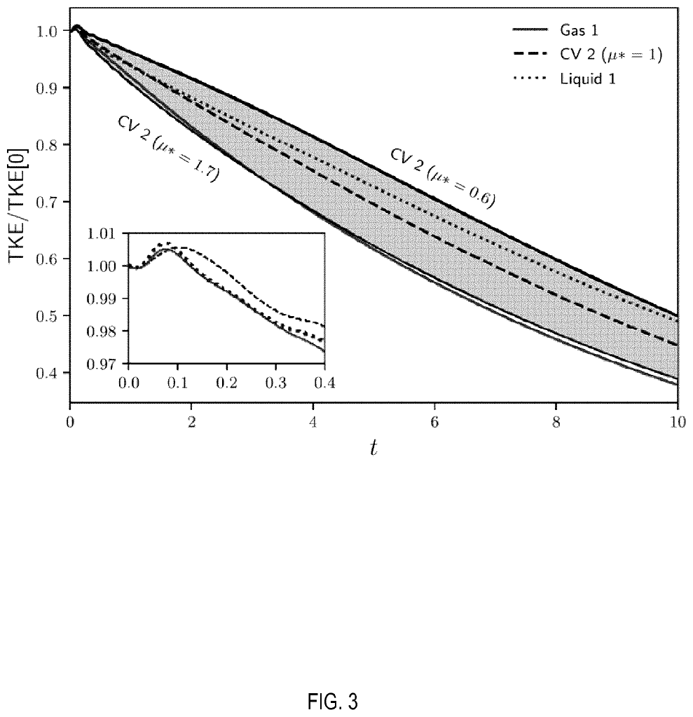

In FIGS. 2A-2B, the timescales of the liquid and gas cases follow the expected trends: ti monotonically decreases (FIG. 2A), while τ_{η} increases (FIG. 2B) as the TKE decays in the continuum phase. We note that the slopes of these timescales are substantially different between the gas and liquid cases. Notably, the τ_{ι} curve is steeper in the gas phase in comparison to the liquid. This can be attributed to the rise in gas viscosity with temperature which results in greater viscous dissipation giving u, and consequently the TKE, a rapid decay rate (FIG. 3).

Referring to FIG. 2B, in terms of th, it can be noticed that in liquid, τ_{η} initially increased and then decreased until t=4 before rising again. By expanding the definition of τ_{η} in equation (3), we see that the Kolmogorov timescale is inversely proportional to the average spatial gradients of the velocity fluctuation (the viscosity cancels out). As the liquid initially heats up- and the viscosity drops—the rapid readjustment causes the average velocity gradients to fall (resulting in an increase in τ_{η}). After the initial transience, the lower viscosity of the flow increases the effective Reynolds number (temporarily reducing τ_{η}) until around t=4, when the bulk viscosity/temperature of the fluid starts to plateau (see FIG. 1) and viscous decay takes hold (increasing τ_{η}).

Referring to FIG. 3, comparing Gas 1 and Liquid 1 plots with CV 2 (μ*=1) also immediately highlights the significance of temperature-dependent viscosity and its potential impact on particle distribution. In FIG. 3, the shaded area represents the boundaries of TKE (solid black lines) as the viscosity increase from 0.6 to 1.7. Here only Gas 1 and Liquid 1 cases are shown as all gas and liquid cases overlapped due to one-way coupling. To further test this effect, Gas 2 was also simulated with no heating (not shown) and it was found that, except for the initial TKE surge due to aggressive heating, the heated and non-heated Gas 2 cases nearly overlapped. This clearly suggests that heating alone (at constant viscosity or for similar change in viscosity) does not significantly affect the TKE decay rate. It is the change in viscosity of different cases which alters the rate of TKE decay.

### Evolution of the Stokes Number

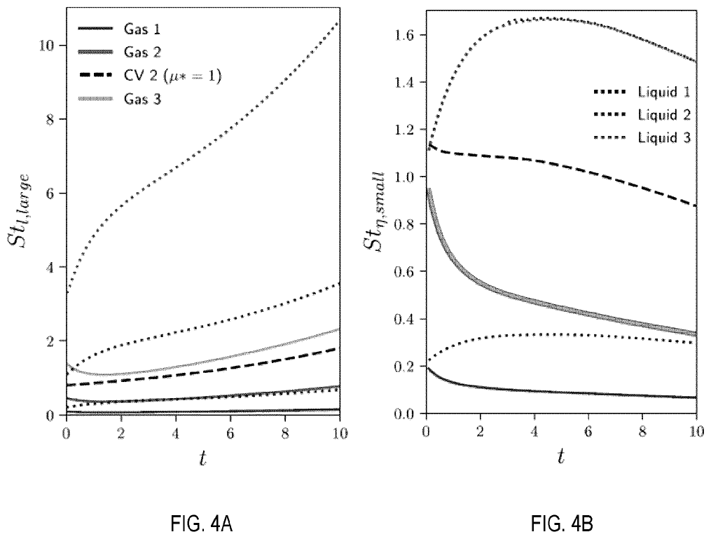

FIG. 4A shows the change in St_{l,large} (large particles) over time. In this plot, there are two critical concepts. Firstly, even though all cases display an increase in St_{l,large} with time, the rise in the liquid cases was much greater than their gas counterparts. This can be attributed to the simultaneous rise in Ta and decrease in τₗ (both contributing to a rise in St_{l,large}) as the fluid heats up and viscosity drops. Secondly, at the beginning of each simulation, the St_{l,large} of the gas curves shows a small dip before monotonically rising from about t=1. However, the liquid cases show a sharp increase at the early times. This behaviour is also true for Gas 1 and Liquid 1, although it is not evident from the plot due to the scale of the other curves. This initial transience is the result of a sudden rise in TKE (see FIG. 3) and rapid adaptation of the flow to the sudden heating. As discussed earlier, the higher viscosity of gas was able to quickly dissipate this energy spike resulting in a rapid drop of St_{l,large} at the early times. The difference in gas and liquid St_{η,small} plots (FIG. 4B) is also attributed to the aforementioned reasons. We note a consistent change in slope of the St_{η,small} in liquid cases at about t=4. This corresponds to the time at which particle temperature stops increasing (FIG. 1); thus viscosity stops decreasing and remains constant. At which point, the liquid cases demonstrate a monotonically decreasing St_{η,small}. Additionally, notably different curves of Gas 2 and CV 2 (μ*=1) again highlight that the Stokes number behavior-especially St_{η,small}—is a strong function of temperature-dependent viscosity.

### Quantification of Particle Clustering

For analyzing the preferential clustering, the RDF was computed at three characteristic time instances: at t=1, 10, and the timestep at which TKE has decreased by half between t=0 and 10. These timesteps were selected as they represent the characteristic snapshots of the flow evolution, where t=1 depict the state of particles shortly after the heating was initiated. The time t=10 was chosen to delineate the state of the flow after a significant drop in TKE. The point of half TKE decay represents the midpoint between these two limit states. Considering the faster TKE decay rate in gas (FIG. 3), the TKE of gas halved at about t=4, whereas for the liquid this was observed at around t=5.

RDF at t=1

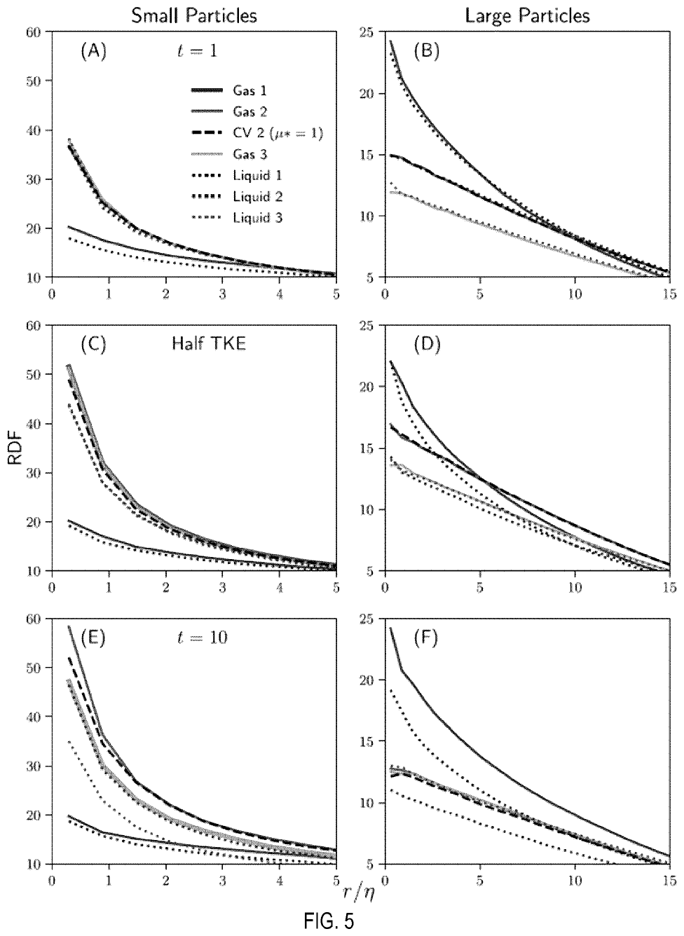

It can be seen in FIG. 5A that except for Gas 1 and Liquid 1 (characterized, at the start of the decay, by St_{η,small}=0.19 and 0.22, respectively), the smaller particles had a greater propensity towards clustering than the larger particles. This can be attributed to the fact that the small particles, in cases 2 and 3, have St_{η,small} close to unity. It can also be observed that both liquid and gas cases (for the same base case number) show nearly identical RDF curves. This is also because at t=1, the corresponding base cases of gas and liquid have St_{η,small} equally distant from unity (FIG. 4), and the viscosity change remains modest after this short time evolution. The reduced clustering of the smaller particles in Gas 1 and Liquid 1 (compared to the base cases 2 and 3) is due to their much smaller St_{η,small} values. At t=1, St_{η,small} of Gas 1 was 0.13 and for Liquid 1 it was 0.29. Since these values are significantly smaller than unity, these smaller diameter particles depicted substantially less clustering. This behavior of small particles of Gas 1 and Liquid 1 was observed throughout this study.

In terms of large particles (FIG. 5B), at t=1 Gas 1 and Liquid 1 depicted the maximum clustering. This is because the large particles in this base case have the smallest diameter compared to the other base cases. Thus, they are most easily affected by the integral scale eddies. Conversely, the large particles of the other gas and liquid cases are not as readily influenced by the turbulence, hence they showed less clustering. The large particles in this study also retained this characteristic clustering pattern at the other two timesteps.

### RDF at Half TKE

FIG. 5C shows the RDF plots of small particles at about the midpoint during the TKE decay. As the TKE has decayed considerably, the gas and liquid RDF curves of the smaller particles start to show larger discrepancies. This is because particle clustering lags behind the thermodynamic and kinematic changes in the flow-particles clustering is a reaction to these changes. Additionally, at this time instant, both gas and liquid cases have reached their final viscosity (recall temperature evolution in FIG. 1). Here, Gas 2 and 3 both have St_{η,small}=0.47, thus their RDF curves are not only alike but they also display the highest clustering at this stage. Similarly, the small particles in Liquid 2 and 3 have RDF curves that collapse and show significant clustering as their St_{η,small}=1.67. Note that despite having St_{η,small}<1, Gas 2 and 3 showed higher clustering than Liquid 2 and 3. This could be because of the higher viscous push on the particles in gas which causes them to gather in the convergence zones. Another possible reason is the viscous capturing of the particles in different high viscosity regions in gas which is described below. Moreover, as shown in FIG. 5C, the small particles of Gas 1 and Liquid 1 show almost equal level of clustering at half TKE, despite having significantly different viscosities and St_{η,small} values. Here, in Gas 1 the St_{η,small}=0.09 is much less than in Liquid 1 (St_{η,small}=0.33), yet the lower viscosity/drag force in the liquid enhanced particle dispersion.

RDF at t=10

FIGS. 5E and 5F show the RDF plots of small and large particles at t=10. Here, because of the significant decay in the TKE, the difference between small and large particles is the most prominent. In FIG. 5E, Gas 2 (small) showed the highest level of clustering with St_{η,small}=0.33. While, despite having similar St_{η,small}, Gas 3 (small) adopted the second highest peak. A similar trend can be seen in Liquid 2 (small) and Liquid 3 (small) as both cases had St_{η,small}=1.48. This pattern is particularly interesting as each carrier fluid phase has identical viscosity in base cases 2 and 3. However, even though the small particles of base cases 2 and 3 are equal in size, the large particles of base case 2 are smaller than that of base case 3. Therefore, the larger particles of base case 3 generate more heat and, as a result, more aggressively transfer this heat to the surrounding fluid. This altered the local turbulence field by decreasing the local density and caused the particles of base case 3 to be pushed away, yielding less clustering in Gas 3 and Liquid 3.

Comparing FIGS. 5A, 5C and 5E highlights a critical effect. As the TKE decayed, the St_{η,small} dropped in Gas 2 and 3 from St_{η,small} at t=1 to St_{η,small}=0.33 at t=10, yet these base cases still showed the highest clustering at all three timesteps. This contradicts the trend in literature that St_{η,small}≈1 corresponds to the maximum clustering. Moreover, higher clustering in Gas 2 and 3 cannot be attributed to the non-local mechanism, as in the present simulations Gas 2 and 3 did not experience St_{η,small}≥1 at the previous timesteps. On the other hand, Liquid 2 and 3 did not deviate from the classical particle distribution behaviour at any timestep. Hence, it can be stated that with increasing viscosity, the clustering behavior is decoupled from St_{η,small}. In other words, as the flow is temporally evolving, maximum clustering will not necessarily be observed at St_{η,small}≈1 as seen in classical particle-laden flows. Instead, the viscous capturing effect, discussed below, which is tied to the history of the particle evolution in the flow is more important. This highlights that St_{η,small} alone cannot be used for predicting clustering in externally heated particles. This explanation is further tested by comparing Gas 2 and CV 2 (μ*=1) plots in FIG. 5. As per FIG. 4, the St_{η,small} of CV 2 (μ*=1) in general monotonically dropped from 1.1 at t=1 to 0.87 at t=10. Hence, at all three timesteps the St_{η,small} of CV 2 (μ*=1) was close to unity. In this regard, if fluid temperature-dependent viscosity (viscous capturing) was not dominantly controlling particle clustering, then the smaller particles of CV 2 (μ*=1) should have depicted the highest clustering. Yet, it is evaluated to be below Gas 2, even though Gas 2 St_{η,small} is less than half of μ*=1), especially at t=10.

### Heating and Decaying TKE Effects

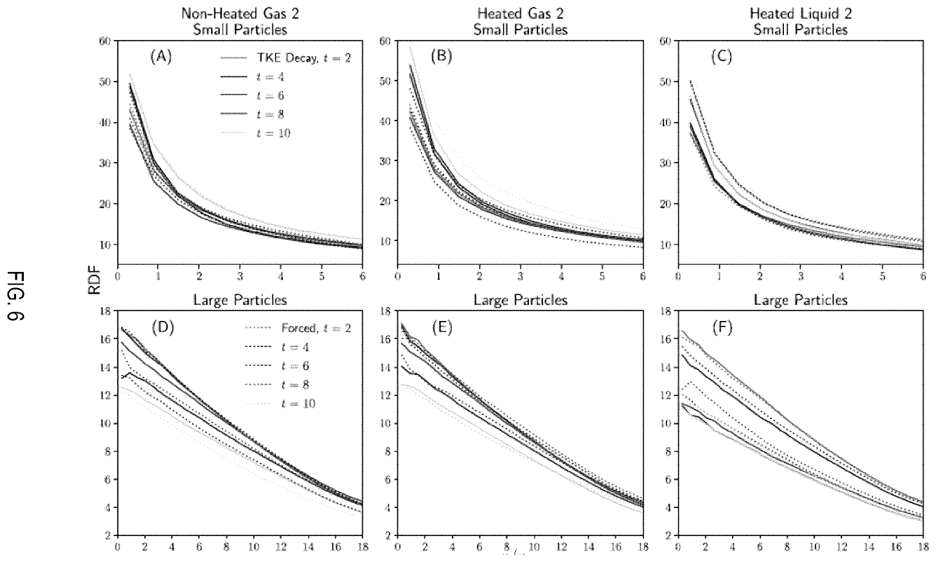

Thus far we have discussed the aggregate effects of particle heating within decaying turbulence. Since both the heating and decaying turbulence can individually influence particle clustering, in this subsection we seek to delineate the influence of each of these effects. This is also important because we want to check if higher clustering, for instance at t=10, is just the result of clusters taking time to develop, or their formation is the direct result of thermodynamic and kinematic changes in the flow. Considering this, we have conducted additional simulations with sustained turbulence (forced TKE), namely with (both a gas- and liquid-like viscosity) and without particle heating. To understand the effect of TKE decay on clustering, we first consider the No Heating cases in FIGS. 6A and 6D. It can be seen in FIG. 6A that the time-based distribution of smaller particles in gas is similar in both forced and decaying TKE cases without particle heating. In terms of larger particles (FIG. 6D), the difference between the two cases become apparent at higher time instances t≥6. However, since smaller particles are mostly responsible for clustering, this disagreement between the two test cases is not critical in this analysis. Hence, it is safe to say that the effect of decaying or sustained turbulence alone does not play a defining role in the clustering of smaller particles.

In terms of the heating cases, FIGS. 6B, 6C, 6E and 6F suggests that forced and decaying turbulence simulations show more significant differences in the particle distribution. This can be attributed to the local density fluctuations at particle position due to heating. Additionally, temperature-dependent viscosity also played a significant role in particle clustering as liquid cases showed greater disagreement between the forced and decaying TKE plots. This supports the claim that particle heating and concomitantly the change in the temperature-dependent viscosity dominates the clustering characteristics of particles.

### Viscous Capturing

In the current simulations, the primary force acting on the particles is due to drag. The drag force is directly tied to the drift velocity, which is a local measure of the relative fluid-particle velocity, as shown in equation (11). Additionally, drag force is correlated with local viscosity of the flow through the coefficient:

$$\frac{{C}_{D}}{{τ}_{p}} = \frac{{C}_{D} {18}_{ρ f} {v}_{f}}{{ρ}_{p} {d}_{p}^{2}} .$$

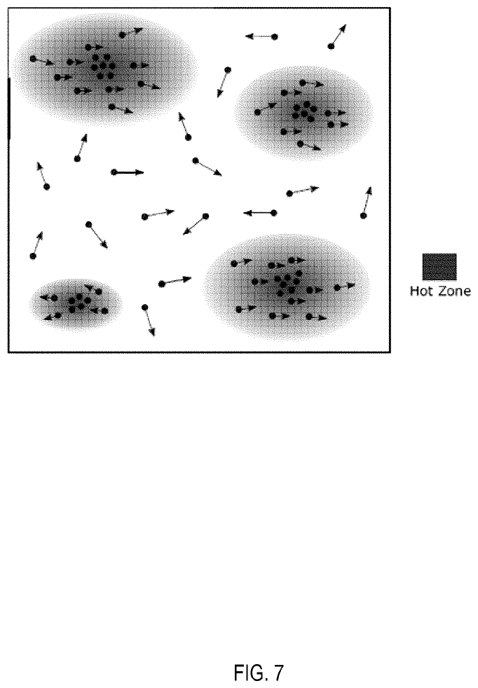

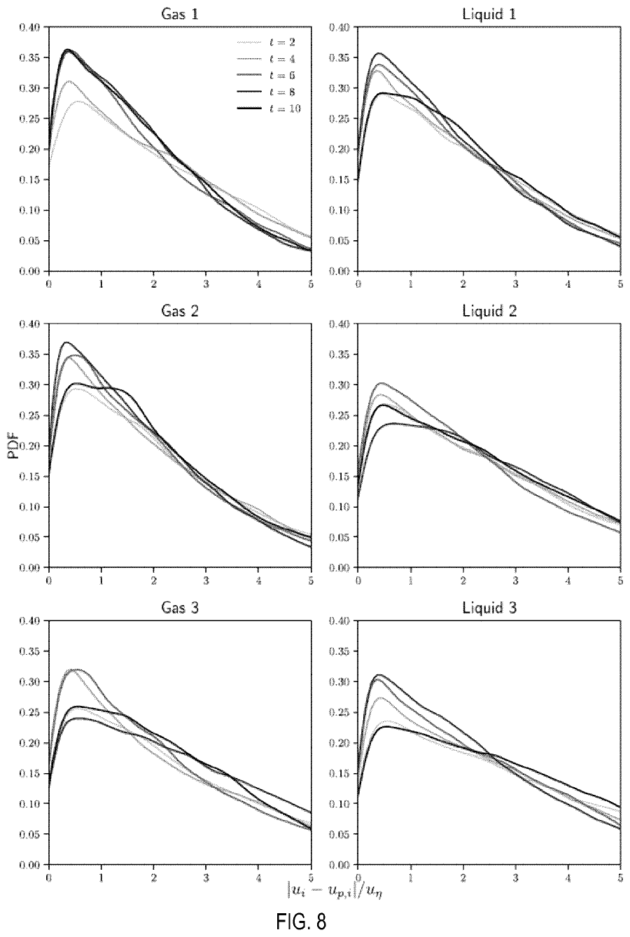

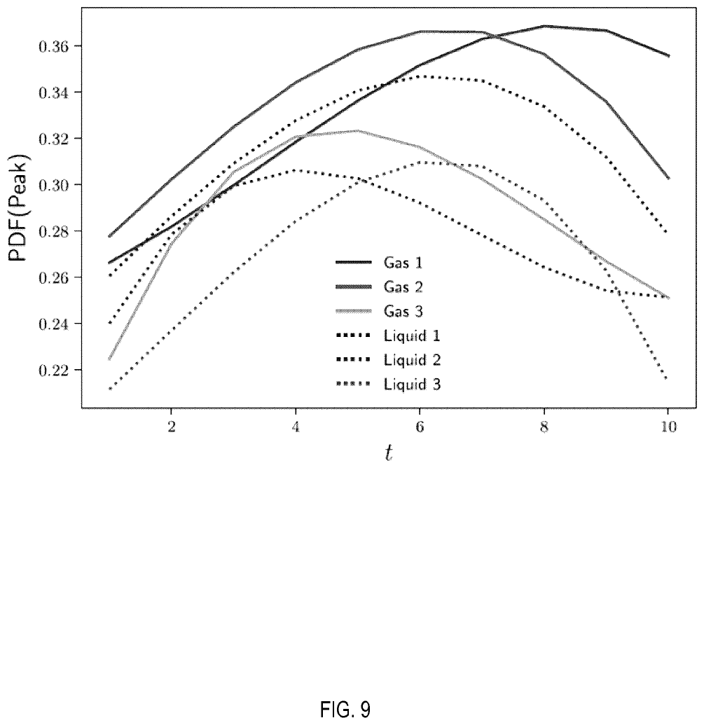

Note that the coefficient of drag, C_{D} is only weakly dependent on viscosity. For a same drift velocity, a higher viscosity will result in a higher drag force on the particle, which acts to reduce the drift velocity. Thus, an increase in the gas viscosity with temperature will result in a greater number of particles that move with the fluid velocity as compared to liquid. This feature is sketched in FIG. 7 for a gas, while FIG. 8 shows the probability distribution function (PDF) of the normalized drift velocity. In FIG. 7, arrows represent fluid-particle drift velocity; the longer the arrow, the higher the drift velocity. In FIG. 8, fluid-particle drift velocity was computed at the locations where the local temperature was one standard deviation higher than the global mean temperature at each timestep. Hence, only the drift velocity in the high temperature zones (with higher viscosity in gas and lower viscosity in liquid) were considered. For clarity the peak values of the PDF in FIG. 8 at |uᵢ−u_{p,i}|/u_{η}≈0 are summarized in FIG. 9. It can be seen that the gas cases typically depicted higher peak values at |uᵢ−u_{p,i}|/u_{η}≈0, which suggests that in gas more particles are moving at a velocity closer to that of the fluid as compared to liquid.

Based on the discussion above, to explain the increased clustering of the small particles in gas, we propose a viscous capturing mechanism. Viscous capturing arises when clustering of heated particles creates a region of higher fluid viscosity (in a gas) which surrounds the zones of higher particle clustering. The higher viscosity, which means larger drag, causes the particles to move with the heated fluid (FIG. 8). As other particles interact with the regions of higher viscosity, the increased drag effectively captures them. Thus, viscous capturing enhances particle clustering when the viscosity increases with temperature, irrespective of the instantaneous Stokes number of the flow. Additionally, once captured, these particles are less likely to leave these viscous regions due to higher viscous dissipation which weakens the vortex and, especially along the stagnation plane, the particle-and-fluid velocity are very similar in hot regions as shown in FIGS. 8 and 9. Thus, this limits the drag force. This behaviour is termed viscous restraining. In the liquid cases, we also observe an increased clustering with time as the turbulence decays, although it is not as prominent as in the gas. In this case, the reduction of viscosity results in a reduced particle drag, hence particles are less readily transported by the continuum phase, meaning that the particles will have a tendency to remain in the cluster, despite showing a slower decay of the TKE (compared to the gas cases).

### Particle Distribution and Heating

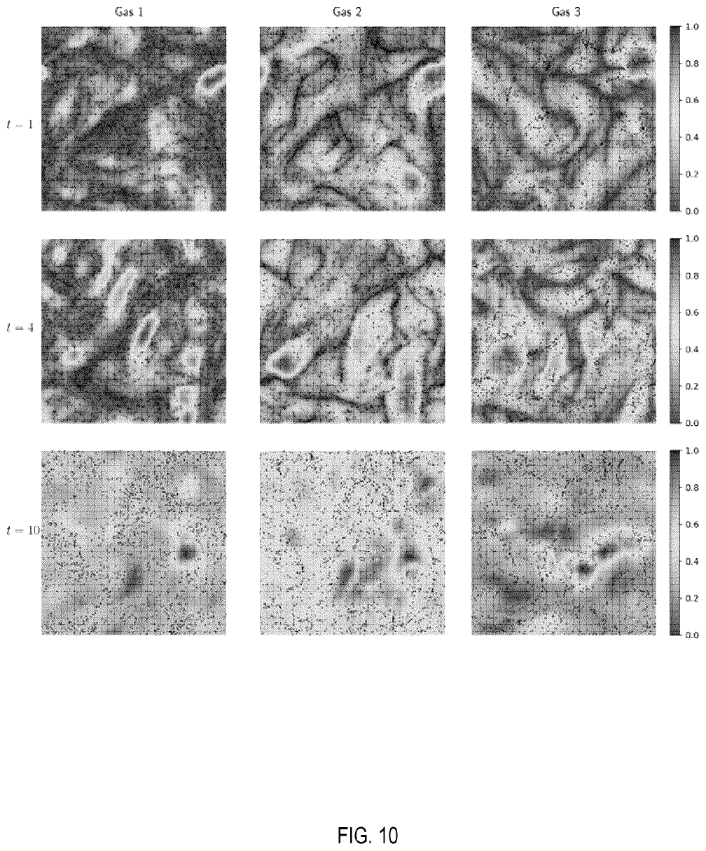

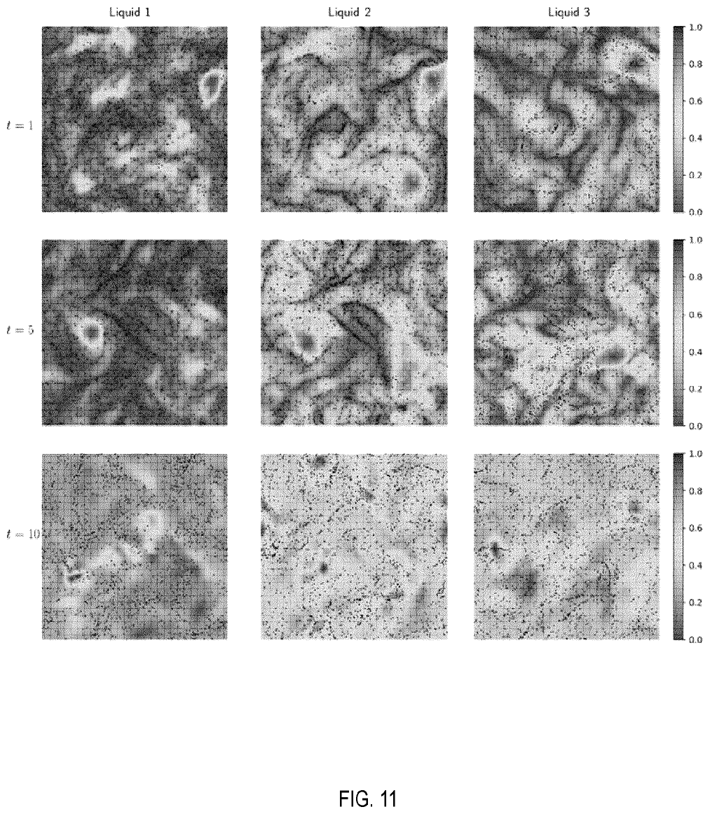

FIGS. 10-11 show the temperature and particle distribution (in a 2D slice) at the selected timesteps. It should be noted that in FIGS. 10-11 temperature is normalized by its maximum value at each timestep. It can be observed that particle clustering occurs in all the test cases irrespective of the St, as shown earlier, and these clusters resulted in hot and cold temperature zones in the fluid. Similar to the RDF plots, base case 1 resulted in the lowest particle clustering in both phases, while base case 2 showed the highest overall clustering at all timesteps. Another important observation is that base case 2 depicts thread-like particle clusters (a characteristic clustering shape due to vorticity in the flow, (Haugen et al., supra), which share the same high-strain location as the hot fluid. This can be attributed to the gathering of particles at the thermal fronts (similar to the scalar fronts observed in (Bec, J. et al, 2014, supra; Carbone, M. et al., supra) These thread-shaped clusters also exist in base case 3, however their location at these timesteps is slightly different from the hot fluid. This is because of the greater inertia of base case 3 particles which results in larger fluid-particle drift velocity and enables the particles to pass through these fluid temperature fronts with ease.

Moreover, by comparing Gas 2 (t=10) contours with FIG. 8A of a similar monodispersed analysis of (Mouallem and Hickey, 2020), it can be seen that bidispersed particles show considerably less clustering than the equivalent monodispersed flow. This is primarily due to the filling of the voids of one particle type by the other as small and large particles gather in different strain rate and vorticity regions. Yet, although bidispersed particles delivered reasonably enhanced heat and particle distribution, clustering still exited.

### Strain Rate and Vorticity

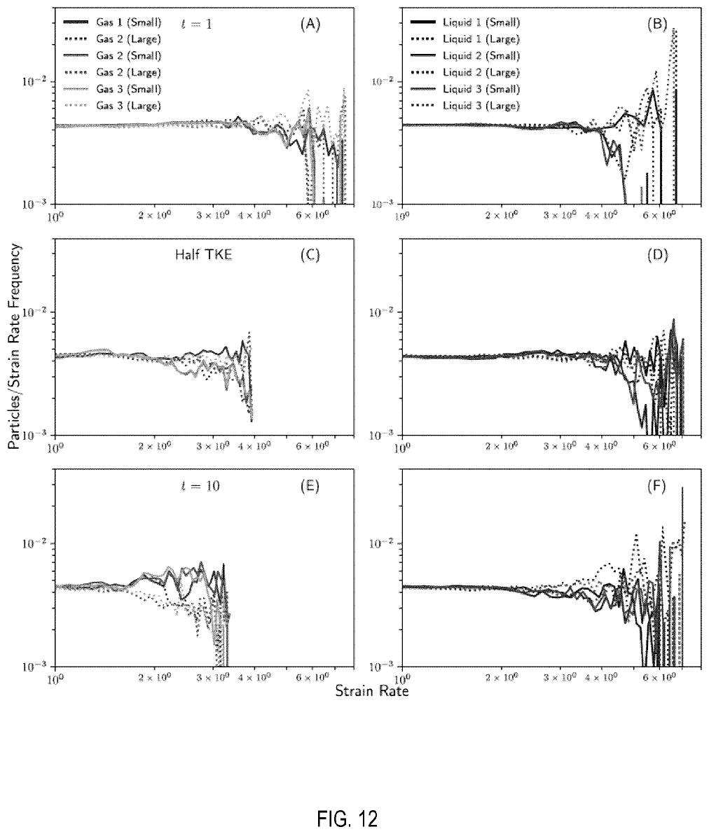

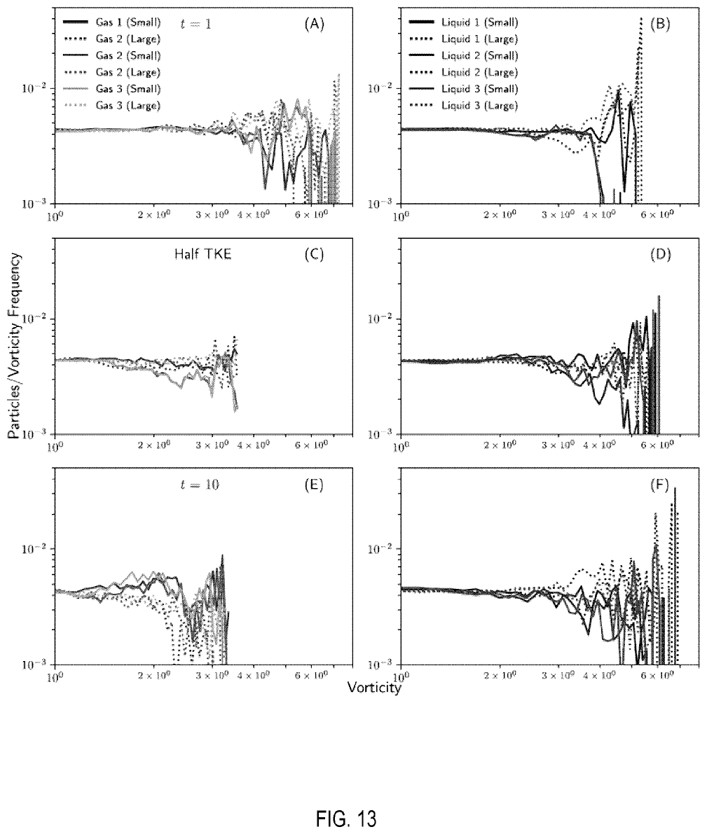

The distribution of the particles as a function of the local magnitude of the strain rate and vorticity of the continuum phase is analyzed in FIGS. 12 and 13. In order to assess the relative distribution of the particles, the probability distribution of particles is normalized by the probability of occurrence of these kinematic variables in the flow (at the respective timestep). This is done to examine if certain strain rates and vorticity regions would affect the grouping of the particles.

As per definition, strain rate (S) is the rate of deformation of the flow field which is mathematically expressed as the symmetric part of the fluid velocity gradient (∇u). While, vorticity (Ω) is the measure of local rotation of the velocity field, numerically computed as the curl of flow velocity (∇×u). Hence, as the isotropic turbulence decays, the maximum velocity gradient and curl are expected to decay, albeit more rapidly for the increased viscosity of the gas than for the liquid.

FIG. 12 shows the size-wise particle to strain rate frequency curves of the gas and liquid cases. As we are normalizing the particle distribution by the occurrence frequency of the strain rate, we are able to assess the relative clustering of the particles in the strain rate domain. For both the gas and liquid cases, the initial section of the curves overlap. This suggests a good correlation between the number of particles and the occurrence frequency of the strain rate; a similar behaviour is also observed for vorticity plots (FIG. 13). Note that in this analysis we are only interested in the peak values especially at high strain rates.

In FIG. 12, it can be seen that particles tend to settle in medium to high strain rate regions. Likewise, starting from t=1 when TKE is high, larger particles depicted greater setting in high strain rate regions. This trend decreased with time and at t=10, smaller particles took over this trend. This can be explained with filtering effect in which as the St increases (St_{l,large} here, see FIG. 4), particles stop responding to timescales smaller than the particles response time (Ayyalasomayajula, S. et al. Phys. Fluids 20 (9), 095104, 2008; Bec, J. et al., J. Fluid Mech. 550, 349-358, 2006). This renders larger particles less responsive to the fluid, thus decreasing their concentration in the high strain rate regions. This behavior suggests a size-based particle distribution as stated earlier, especially in the context of particle heating. Additionally, it can also be observed in FIG. 12 that although liquid cases show similar trends at t=1 and half TKE, the trends of large and small particles are relatively similar at t=10. Considering equation (4), as TKE decays more slowly in liquid, u in liquid is higher than gas at later timesteps (FIG. 2). Thus, as per filtering effect larger particles in liquid respond to more timescales at t=10 as compared to gas. Additionally, the particle concentration peaks are much higher in the liquid. This is due to higher fluid-particle velocity fluctuations in liquid based on lower viscous dissipation.

FIG. 13 presents the distribution of particles in different vorticity regions. Unexpectedly, the particle distribution with vorticity is similar to the strain rate plots. Yet, as previously noted in the literature, particles cluster in low vorticity regions, which is especially evident with smaller particles in the gas. In the gas-like viscosity cases, this trend can be explained by viscous capturing which holds particles in different vorticity regions. In the case of liquid however, the higher concentration of particles in such regions is due to the low drag force and consequently high drift velocity (FIG. 8) of the particles.

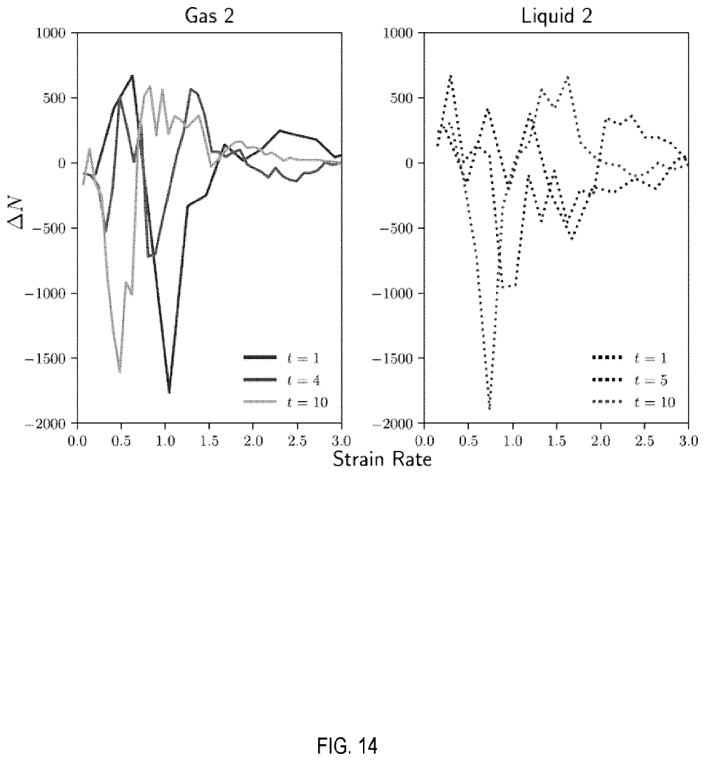

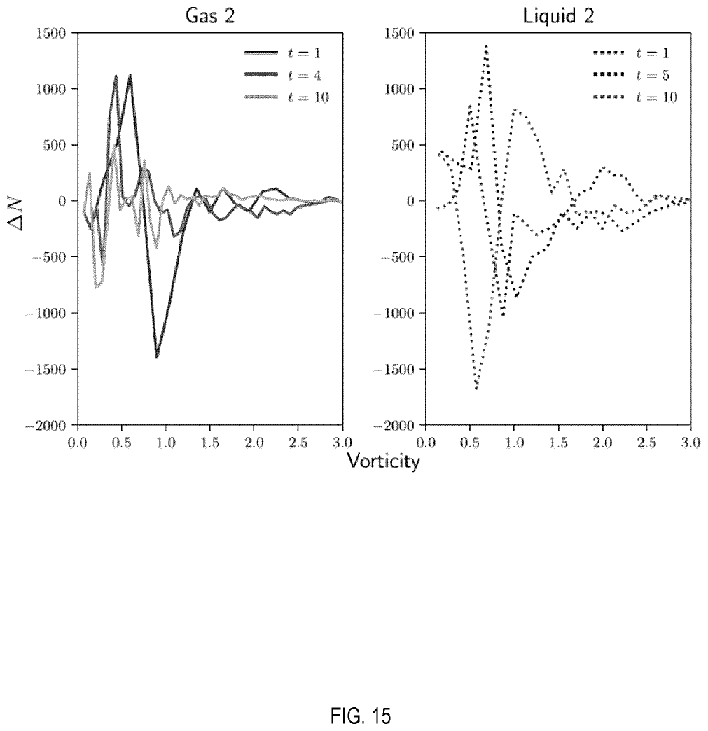

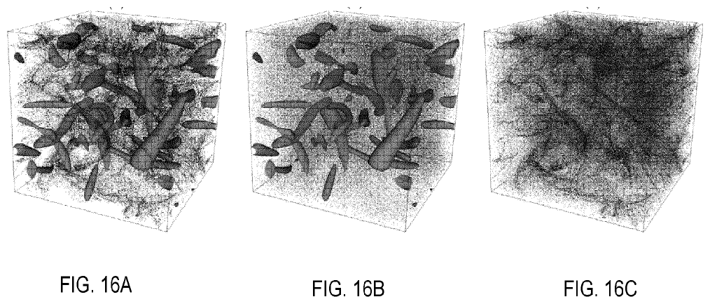

FIGS. 12 and 13 provide a proof of the concept that particles of different sizes globally settle in different strain rate and vorticity regions. In FIGS. 12 and 13, the normalized particle concentration highlights the importance of strain rate and vorticity occurrence frequency, as higher existence of a certain strain rate or vorticity region enables more particles to either settle or avoid that region. However, this normalization cause the details of particle distribution in low strain rate and vorticity regions to be lost. Thus, non-normalized number difference of small and large particles (ΔN) with respect to strain rate and vorticity in Gas 2 is shown in FIGS. 14 and 15. These figures highlight that low strain rate regions are populated by larger particles, while smaller particles dominate in low vorticity locations. This further proves that the voids of one particles size are filled by the other size. To further elaborate this trend FIG. 16 presents the 3D distribution of particles and vortices in Gas 2. In FIG. 16, small and large particles are represented by black and red colors, respectively, while vortices are shown with teal blue structures. It can be seen in FIG. 16A that smaller particles tend to cluster around the vortical structures, whereas larger particles are not significantly influenced by them (FIG. 16B). Lastly, FIG. 16C shows that the voids created by smaller particles are filled by larger particles. Although not presented here, similar results are observed in Liquid 2.

### CONCLUSIONS

A DNS investigation was conducted to study the clustering of heated bidispersed particles in variable viscosity carrier fluids. The focus of this work was on understanding the effect of gas- and liquid-like temperature-dependent viscosity on the preferential concentration. Three base cases, each containing particle species of two different diameters, were simulated in decaying isotropic turbulence. For the two carrier fluids, all operating parameters were kept alike except the viscosity—the gas viscosity increased with temperature following a power-law, while the viscosity decreased with temperature in the liquid. Based on this, following are the primary findings of this research:
In classical decaying isotropic turbulence, St_{l,large} is expected to increase and St_{η,small} decreases as the flow evolves. Yet, in our study, the external particle heating combined with the temperature-dependent viscosity caused the St_{l,large} and St_{η,small} evolution to deviate from the standard trend in decaying isotropic turbulence.
Overall, the smaller particles showed a much higher preferential concentration than the larger particles in both gas and liquid. Similarly, particles in the liquid phase depicted better dispersion as compared to gas, due to the lower drag force when heated.
Viscous capturing is a proposed mechanism by which the increased fluid viscosity acts to enhance the particle clustering as the turbulence decays, irrespective of the Stokes number of the flow.
At high viscosity and low TKE, preferential concentration in gas is decoupled from its characteristic St_{η,small} values. Hence, St_{η,small}≈1 based prediction of particle clustering is not accurate in the applications involving particle heating or increasing fluid viscosity.
It was also discovered that instead of particles settling in high strain rate and low vorticity regions, bidispersed particles tend to prefer moderate to high strain rate and medium-low to high vorticity regions. In terms of lower values of these parameters, smaller particles settle in low vorticity and larger particles showed inclination towards low strain rate regions. Thus, further probing is required for characterizing the global distribution of bi- and polydispersed particles based on vorticity and strain rate Correspondingly, it is also important to take into account the occurrence frequency of different strain rate and vorticity regions as particle clustering is highly dependent on these parameters.
The gathering of particles in a range of vorticity and strain rate regions, dissimilar dispersion behavior of heated large and small particles, as well as the influence of one heated particle size on the distribution of the other indicates that at any given instance, particles of different sizes cluster at distinct turbulent scales and locations. Hence, polydispersed particles are a superior choice for clustering-sensitive applications.

### Applications

From this study, it was found that fluid viscosity plays a critical role in the clustering and distribution of heated particles. Therefore, it should be considered as one of the key parameters when designing a heated multiphase system. For example, variable viscosity flows can be used to drive a desired change, such as the clustering of energetic particles.

Clustering of energetic particles (e.g., metals and/or metal oxides, metal alloys, nanothermites and/or microthermites) may be advantageous for various applications. For example: multi-fuel systems to concentrate the turbulence driven system, where pockets of smaller particles and larger particles that are more homogenously distributed in the turbulence flow; influencing and modulating frequencies of turbulence by preferential cluster of particles in flow allowing for the ability to modulate frequencies of the turbulence, to dampen the regions of the flow; separation of a sized particle that clusters by heating, thus increasing rate of clustering allowing for the synthesize of difference sized particles; clustering particles from nano to micro scales to extract the preferential cluster at different scales; or enabling uniform combustion of a fuel in a working fluid preheating phase, to allow the nanoparticles to cluster that can be combusted to drive reactions.

Various examples of heated multiphase systems for propulsion, combustion, energy generation, and/or additive manufacturing using bidispersed or multidispsersed particles are described below. The systems may be implemented on Earth, in space, cislunar space, on the Moon, Mars or on extraterrestrial environments such as asteroids, planets or other Moons.

### Multi-Source, Multi-Phase Reactors

A “reactor” as used herein is not limited to a nuclear reactor, but may refer to any system that uses fusion, fission, thermal (e.g., combustion), chemical, electromagnetic or inductive, or other energy sources for propulsion, power generation, or for at least one step in a chemical or material synthesis process. For example, the reactors described herein may be used to chemically synthesize energetic particles (e.g., metallic fuel particles).

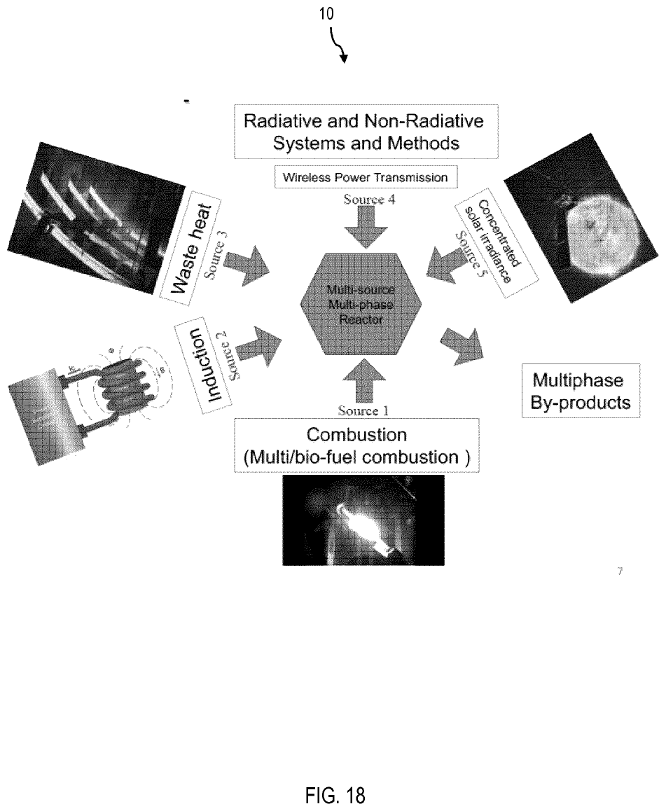

Referring to FIG. 18, shown therein is a diagram of a multi-source multi-phase reactor 10. “Multi-source” refers to the fact that the energy input to the reactor may be from multiple sources such as waste heat, solar irradiance, combustion of a fuel, induction, etc. “Multi-phase” refers to the working fluid, fluid material, products and/or byproducts of the reactor having different phases and/or clustering as described above.

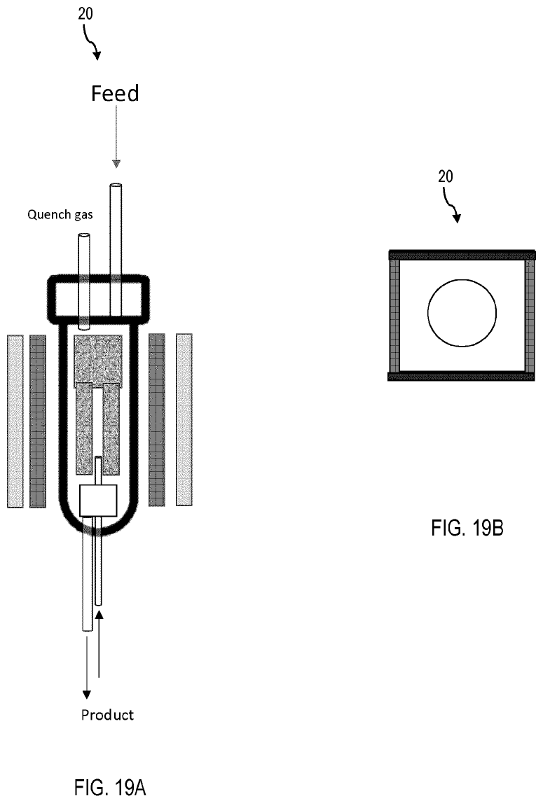

FIGS. 19A-19B are side and top view diagrams, respectively, of a multi-phase reactor 20, according to an embodiment. The reactor 20 includes a reaction chamber containing a catalyst for converting a feed material (slurry, liquid, gas or a combination thereof) into products. A quench gas is circulated through the reaction chamber to a feed-effluent heat exchanger for regulating the heating in the chamber. The reactor 20 includes a heating system (e.g., heating elements, coils) for supplying heat to the reaction chamber. The reactor 20 includes a magnetic drive system including magnets, electromagnets or a Halbach array for generating a magnetic field for suspension and hydromagnetic driving of the feed material through the reactor. As described above, the heating system and hydromagnetic drive system can be modulated to ensure optimal dispersion and clustering of the feed material for reaction with the catalyst and conversion into the product (e.g., energetic particles).

FIG. 19C is a diagram of a multi-phase reactor, 30 according to an embodiment. The reactor 30 includes a cast aluminum cavity containing a reaction tube. The reaction tube contains a catalyst bed that may be packed, fluidized or a slurry. The reactor includes a heating system including variable-frequency microwave generator for heating the cavity and reaction tube therein, and a temperature sensor for regulating the microwave generator. The cavity may include a magnetohydrodynamic drive system wrapped around the tube for mixing of the products with catalyst inside the reaction tube. As described above, the heating system and MHD drive system can be modulated to ensure optimal dispersion and clustering of the products with catalyst for reaction and conversion into the byproduct (e.g., energetic particles).

In the reactors of FIGS. 18-19 temperature in the reaction chamber/tube decreases as you move away from the core/center. Accordingly, to maintain a uniform optimal temperature within the chamber/tube, the heating system may include inductive heating for heating the core of the chamber/tube and microwave heating to heat the periphery of the chamber/tube.

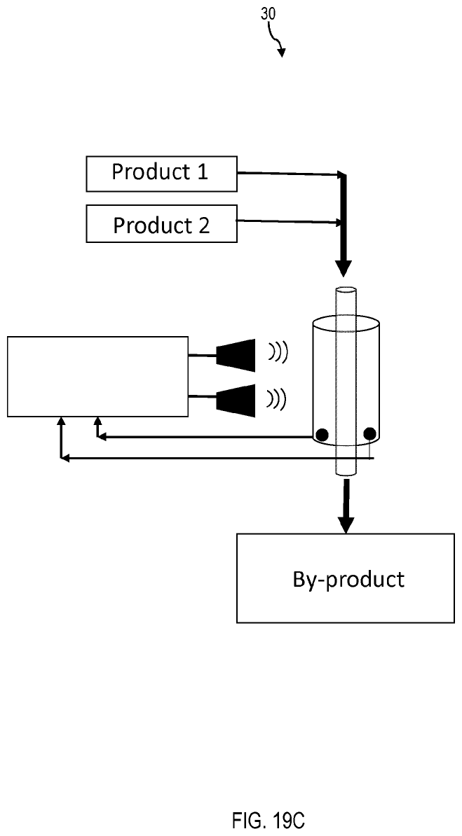

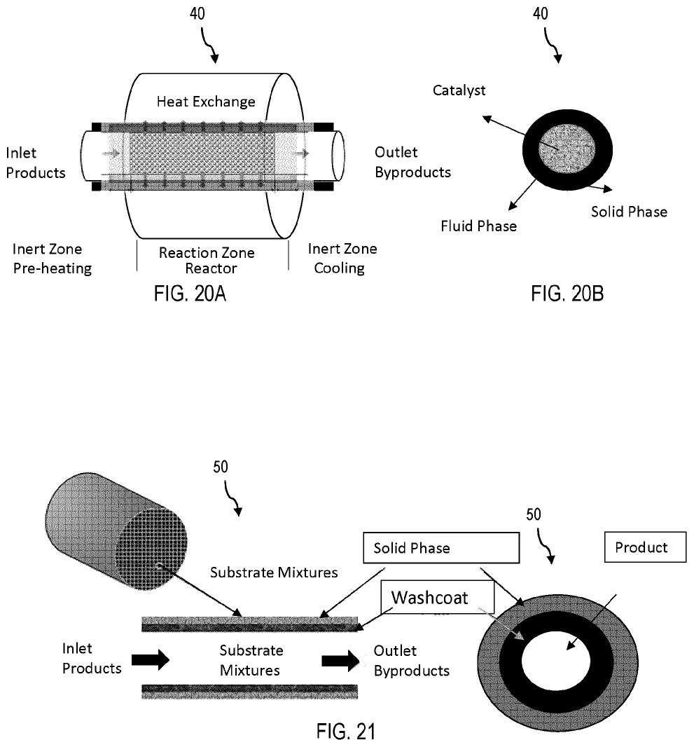

FIGS. 20-21 are diagrams of catalyst bed structures 40, 50, according to several embodiments. The catalyst structures 40, 50 may be implemented in the reactors 20, 30 shown in FIGS. 19A-19B. The catalyst may be implemented as a scaffold through which a fluid material is passed as shown in FIGS. 20A-20B or a wash coat catalyst as shown in FIG. 21. In either case, the catalyst is surrounded by a solid phase structure through which heat is exchanged into a reaction zone. As described above, the heat into the catalyst structures may be modulated to ensure optimal dispersion and clustering of the fluid material particles with the catalyst. The fluid material may be a slurry, a liquid, a gas, or a combination thereof.

Referring to FIGS. 20A-20B, the catalyst scaffold structure may be pumped in and out of the reaction zone. The scaffold may be silica based and may be additively manufactured. The scaffold is generally a porous material with functionalized catalyst beads embedded therein. The catalyst scaffold may be heated to the Curie temperature of the scaffold material to provide an optimal temperature for the reaction.

The particular catalyst may be selected according to the specific application or purpose of the reactor. The functionalized catalyst beads may be metals or metal oxide spheres according to various embodiments. The spheres may be inductively heated, or heated by other means (e.g., microwaves, laser and/or other electromagnetic radiation), to transfer heat to the working fluid and products in the reaction chamber/tube.

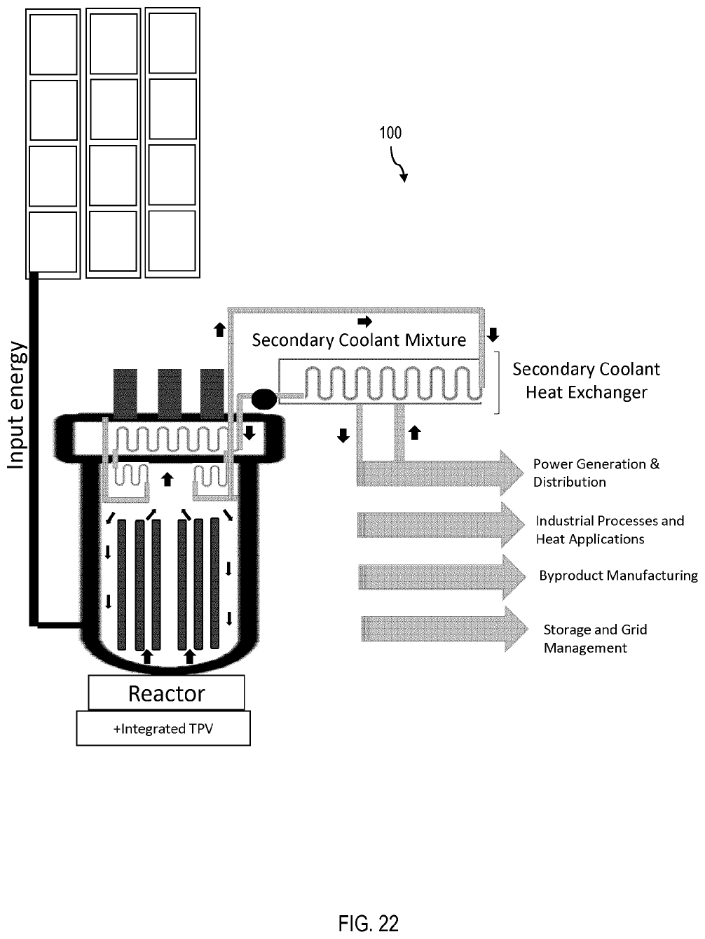

Referring to FIG. 22, shown therein is a diagram of a hybrid reactor 100, according to an embodiment. The hybrid reactor includes a molten salt reactor and an integrated thermal conversion system for converting waste heat to electricity. The thermal conversion system includes thermophotovoltaics. Input energy to the molten salt reactor is preferably “clean” energy from renewable and/or storage sources. The hybrid reactor 100 includes a secondary coolant system and heat exchanger. Heat exchanged through the secondary coolant system may be used to drive power generation and distribution, industrial processes, byproduct manufacturing.

### Additive Manufacturing Systems

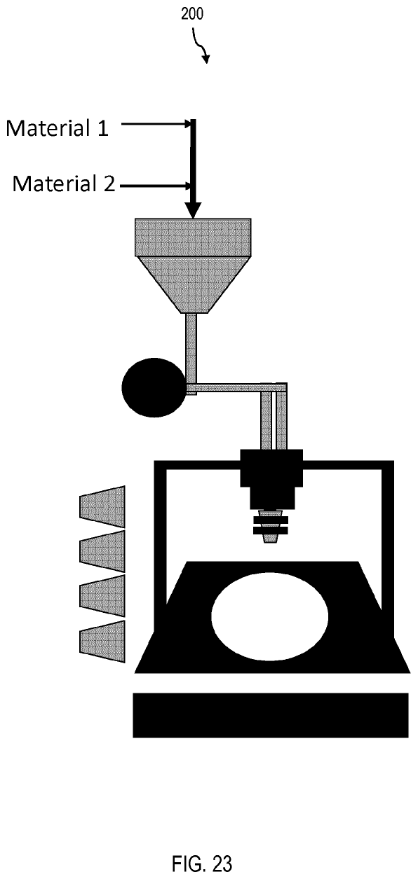

Referring to FIG. 23, shown therein is a diagram of an additive manufacturing printer 200, according to an embodiment. The printer 200 is configured for heating one or more printable materials for additive manufacturing. The printable material may be provided as a spool. The printer may include a hopper or feeder for storing the printable material. The printable material may include additives which aid in liquification and/or clustering of the printable material particles.

The printer 200 includes a detachable liquefier chamber where the printable material is heated and liquefied to an extrudable state. The printer 200 includes a nozzle in fluidic connection with the liquefier chamber, through which the printable material is extruded onto a platform or substrate. The printer 200 includes a pump or compressor for forcing the material through the liquefier chamber and nozzle. The printer 200 includes a platform for holding the substrate for extruding the material thereon. The platform can be moved in X, Y, Z dimensions and in a circular motion. The printer 200 includes a multi-source energy system (e.g., configured for wireless energy transmission).

The printer 200 includes a multi-phase heating system for heating the liquefying chamber and heating the material therein to various sizes of particle clustering for extrusion. The heating system may also be configured to heat the nozzle and the platform for various sizes of particle clustering during and/or after extrusion. The heating system may be configured to independently control the heating of the liquefying chamber, the nozzle and the platform at different temperatures. The heating system may use induction, microwaves, laser, heating elements, or a combination thereof. The printer 200 includes an array of energy sources for power the printer. As described above, to maintain a uniform optimal temperature within the chamber/tube, the heating system may include inductive heating for heating the core of the chamber and microwave heating to heat the periphery of the chamber.

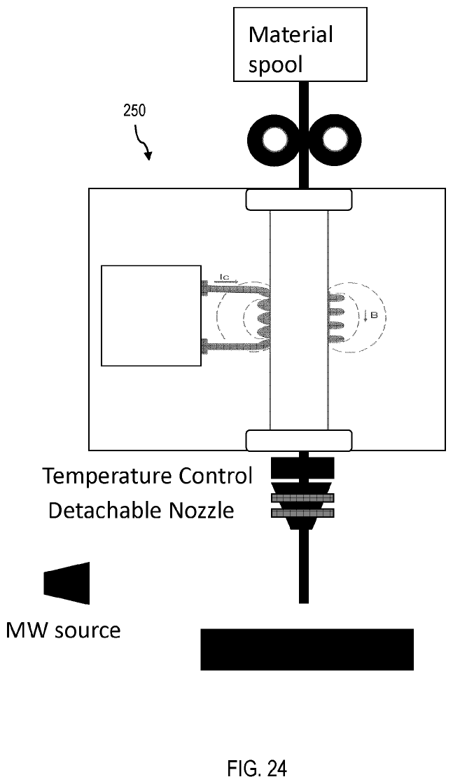

Referring to FIG. 24, shown therein is a multi-phase heating system 250 for additive manufacturing, according to an embodiment. The heating system 250 may be the heating system in the printer 200 shown in FIG. 23 and is for heating the liquefying chamber and a reaction chamber/tube therein. According to various embodiments, the reaction chamber/tube may be any one of the chamber/tubes shown in FIGS. 20-21. The heating system may also be configured to heat the nozzle and the platform for various sizes of particle clustering during and/or after extrusion.

The heating system 250 may use inductive heating coils wrapping around the reaction chamber/tube (as shown). According to other embodiments, the heating system 250 may include microwaves, laser, heating elements, or a combination thereof for heating the reaction chamber and/or the nozzle. As described above, to maintain a uniform optimal temperature within the chamber/tube, the heating system may include inductive heating for heating the core of the chamber and microwave heating to heat the periphery of the chamber.

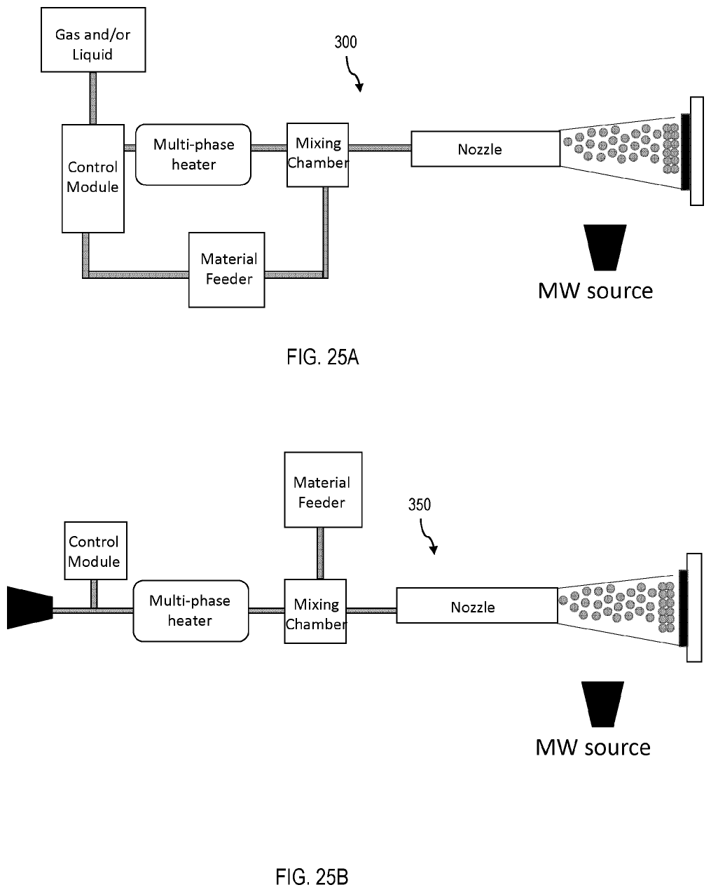

Referring to FIGS. 25A-25B, shown therein are multi-phase cold spraying systems 300, 350, according to several embodiments. FIG. 25A shows a high-pressure system 300; FIG. 25B shows a low-pressure system 350.

The multi-phase cold spraying systems 300, 350 include a multi-phase heating system for heating a material to be sprayed and a carrying fluid (gas and/or liquid) to various sizes of particle clustering for cold-spraying. The multi-phase heating system may use induction, microwaves, laser, heating elements, or a combination thereof for heating the material. The spraying systems 300, 350 include a mixing chamber where the material is mixed with the carrying fluid. A control module regulates the amounts of material and carrying fluid that are mixed. From the mixing chamber, the material/carrier fluid is forced through a nozzle for spraying the material onto a substrate. A microwave source may be positioned adjacent to the nozzle outlet to heat the material/carrier fluid to various sizes of particle clustering as it is sprayed/deposited onto the substrate. The low pressure system 350 includes a compressor for adding air to the mixing chamber.

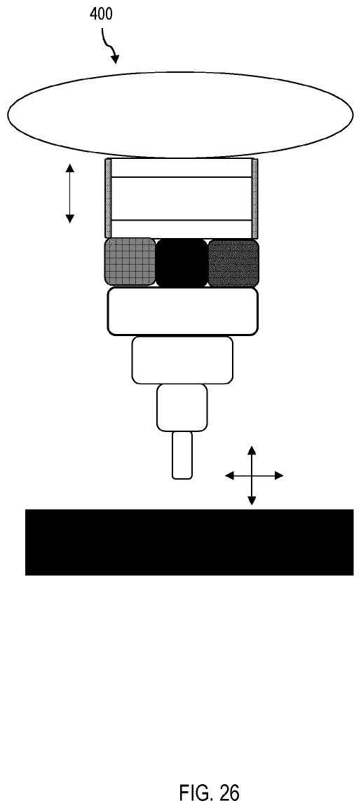

Referring to FIG. 26, shown therein is a diagram of a mobile printing system 400, according to an embodiment. The mobile printing system 400 includes an aerial craft (e.g., an airship, drone, or the like) to which an additive manufacturing printer is mounted. The airship is used for transporting and orienting the printer above a substrate or surface. The airship further acts as a power supply for the printer and includes batteries or an onboard energy generation system (e.g., using solar panels or rectennas).

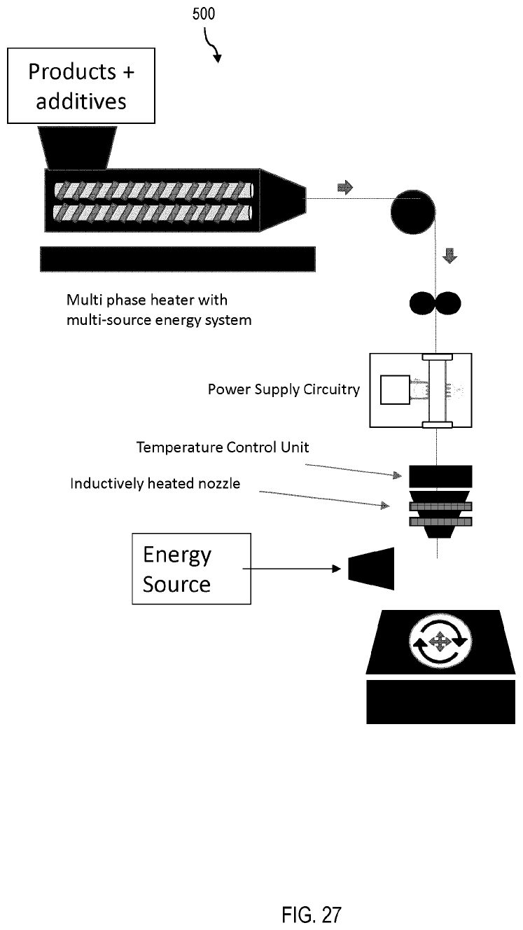

Referring to FIG. 27, shown therein a diagram of a multi-phase heating system with a multi-source energy system 500. Materials including products and additives are processed and/or heated into an additive manufacturable material The additive manufacturable material is extruded to an inductively heated system, where material is energized and deposited on the printing platform. The printing platform moves in the x, y, z, and circular directions. Furthermore, an energy source may be coupled to energize the additively manufactured material for post-processing materials. A plurality of materials may be used to create a plurality of additively manufacturable surfaces and/or structures. These system and processes may be used on Earth and in Space.

The printer is generally similar to the printers shown in FIGS. 23-24 and includes hoppers or spools for storing a plurality of printable materials. The printer further includes a liquifying/reaction chamber, a multi-phase heating system and a nozzle. The multi-phase heating system is configured for heating the liquefying/reaction chamber and heating the material therein to various sizes of particle clustering for extrusion. The heating system may also be configured to heat the nozzle during extrusion. The heating system may be configured to independently control the heating of the liquefying chamber and the nozzle at different temperatures. The heating system may use induction, microwaves, laser, heating elements, or a combination thereof.

While the above description provides examples of one or more apparatus, methods, or systems, it will be appreciated that other apparatus, methods, or systems may be within the scope of the claims as interpreted by one of skill in the art.

1. A multi-phase reactor, comprising:
a reaction chamber for containing a catalyst, wherein the catalyst reacts with a fluid material; and
a heating system arranged around the reaction chamber, for heating the reaction chamber, the heating system comprising:
a first heater for heating a core of the reaction chamber; and
wherein combined heating from the first heater and the second heater provide the reaction chamber at a temperature for clustering of fluid material particles for reaction with the catalyst.

2. The multi-phase reactor of claim 1, wherein a second heater for heating a periphery of the reaction chamber,

3. The multi-phase reactor of claim 1, wherein the first heater is an induction heater wrapping around the reaction chamber.

4. The multi-phase reactor of claim 1, wherein the second heater is one of: a microwave heater, a heating element and a laser.

5. The multi-phase reactor of claim 1, wherein the fluid material is a slurry, a liquid, a gas, or a combination thereof.

6. The multi-phase reactor of claim 1, wherein the catalyst comprises:
a porous scaffold through which the fluid material can flow; and
functionalized catalyst beads embedded in the porous scaffold.

7. The multi-phase reactor of claim 1, wherein the catalyst comprises a wash coat catalyst.

8. The multi-phase reactor of claim 5, wherein the catalyst beads are a metal or a metal oxide.

9. The multi-phase reactor of claim 5, wherein the scaffold and catalyst beads are pumped into the reaction chamber.

10. The multi-phase reactor of claim 1, where in the modulating frequencies of turbulence by preferential cluster of particles are utilized to dampen flow.

11. The multi-phase reactor of claim 1, wherein heating is used for separation of various sized particles.

12. The multi-phase reactor of claim 1, wherein heating is used to cluster a first cluster of particles, which are used to ignite a second cluster of particles.

13. The multi-phase reactor of claim 1, wherein a uniform flow is enabled using heat and/or combustion of smaller particles.

14. The multi-phase reactor of claim 1, wherein, the clustered particles are modulated to ensure optimal dispersion and clustering of the fluid material particles with the catalyst.

15. The multi-phase reactor of claim 1, wherein the fluid material is a slurry, a liquid, a gas, or a combination thereof.

16. An additive manufacturing printer, comprising:
a platform for receiving a printable material thereon;
a liquefier chamber, wherein the printable material is heated to an extrudable state within the chamber;
a nozzle in fluidic connection with the chamber for extruding the printable material onto the platform; and
a heating system arranged around the chamber, for heating reaction chamber and the printable material therein, the heating system comprising:
a first heater for heating a core of the chamber; and
wherein combined heating from the first heater and the second heater provide the chamber at a temperature for clustering of printable material particles for extrusion through the nozzle.

17. The additive manufacturing printer of claim 16, a second heater for heating a periphery of the chamber,

18. The additive manufacturing printer of claim 16, wherein the first heater is an induction heater wrapping around the chamber.

19. The additive manufacturing printer of claim 16, wherein the second heater is one of: a microwave heater, a heating element and a laser.

20. The additive manufacturing printer of claim 16, wherein the heating system further includes a third heater for heating the nozzle to a temperature for optimal clustering of the printable material as it is extruded through the nozzle.

21. The additive manufacturing printer of claim 20, wherein the heating system further includes a fourth heater for heating the platform to a temperature for optimal clustering of the printable material after extrusion from the nozzle.

22. The additive manufacturing printer of claim 16, further comprising a mixing chamber for mixing the printable material with a carrier fluid.

23. The additive manufacturing printer of claim of claim 16, further comprising a compressor for forcing the printable material through the chamber and the nozzle.

24. The additive manufacturing printer of claim 16, wherein printable surface and structures are used for data and computing purposes.

25. The additive manufacturing printer of claim 16, wherein a multi-source energy sourced is coupled with the printer to synthesize larger particles through clustering.

26. A mobile additive manufacturing system comprising:
an aerial craft; and
an additive manufacturing printer mounted to the aerial craft.

27. The mobile additive manufacturing system of claim 26, wherein the additive manufacturing printer comprises:
a liquefier chamber, wherein a printable material is heated to an extrudable state within the chamber;
a nozzle in fluidic connection with the chamber for extruding the printable material onto the platform; and
a heating system arranged around the chamber, for heating reaction chamber and the printable material therein, the heating system comprising:
a first heater for heating a core of the chamber; and
a second heater for heating a periphery of the chamber,
wherein combined heating from the first heater and the second heater provide the chamber at a temperature for optimal clustering of printable material particles for extrusion through the nozzle.
